(19) United States
(12) Patent Application Publication
(10) Pub. No.: US 2014/0035829 A1
(43) Pub. Date: Feb. 6, 2014

(54) ADJUSTING A DISPLAYED WIDGET OR DELINEATED TOUCH-SELECTABLE AREA OF A TOUCH SCREEN DISPALY IN RESPONSE TO A PREDICTED TOUCH-CONTACT SITE OF AN APPROACHING USER-APPENDAGE

(71) Applicants: Roderick A. Hyde, Redmond, WA (US); Jordin T. Kare, Seattle, WA (US); Lowell L. Wood, JR., Bellevue, WA (US)

(72) Inventors: Roderick A. Hyde, Redmond, WA (US); Jordin T. Kare, Seattle, WA (US); Lowell L. Wood, JR., Bellevue, WA (US)

(73) Assignee: Searete LLC, a limited liability corporation of the State of Delaware

(21) Appl. No.: 13/562,794

(22) Filed: Jul. 31, 2012

Related U.S. Application Data
(63) Continuation-in-part of application No. 13/562,685, filed on Jul. 31, 2012.
Application No. 13/562,685 is a continuation-in-part of application No. 13/562,736, filed on Jul. 31, 2012.

(51) Int. Cl. G06F 3/041

(52) U.S. Cl. 345/173

(57) ABSTRACT

Described embodiments include a device, method, and computer program product. A hand-held computing device has a touch-sensitive display surface. The device includes a screen manager circuit configured to delineate a touch-selectable area on the touch-sensitive display surface. The device includes a display circuit configured to display a widget in a positional relationship with the delineated touch-selectable area. The device includes an incoming-movement detector circuit configured to sense a motion of a user appendage approaching the touch-sensitive display surface. The device includes a prediction circuit configured to predict a touch-contact site on the touch-sensitive display surface of the approaching user appendage, the predicted touch-contact site at least partially based on the sensed motion. The device includes a display adjustment circuit configured to apply a compensating adjustment to the displayed widget or the delineated touch-selectable area, the compensating adjustment responsive to the predicted touch-contact site.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### Related Applications

For purposes of the USPTO extra-statutory requirements, the present application constitutes a continuation-in-part of U.S. patent application Ser. No. ______, entitled TOUCH SCREEN DISPLAY COMPENSATED FOR A CARRIER-INDUCED MOTION, naming Roderick A. Hyde, Jordin T. Kare, and Lowell L. Wood, Jr., as inventors, filed Jul. 31, 2012, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled ADJUSTING A DISPLAYED WIDGET OR DELINEATED TOUCH-SELECTABLE AREA OF A TOUCH SCREEN DISPLAY IN RESPONSE TO AN APPROACHING USER-APPENDAGE, naming Roderick A. Hyde, Jordin T. Kare, and Lowell L. Wood, Jr., as inventors, filed Jul. 31, 2012, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

For example, and without limitation, an embodiment of the subject matter described herein includes a hand-held computing device having a touch-sensitive display surface. The hand-held computing device includes a screen manager circuit configured to delineate a touch-selectable area on the touch-sensitive display surface. The hand-held computing device includes a display circuit configured to display a widget in a positional relationship with the delineated touch-selectable area. The hand-held computing device includes an incoming-movement detector circuit configured to sense a motion of a user appendage approaching the touch-sensitive display surface. The hand-held computing device includes a prediction circuit configured to predict a touch-contact site on the touch-sensitive display surface of the approaching user appendage, the predicted touch-contact site at least partially based on the sensed motion. The hand-held computing device includes a display adjustment circuit configured to apply a compensating adjustment to the displayed widget or the delineated touch-selectable area, the compensating adjustment responsive to the predicted touch-contact site.

In an embodiment, the hand-held computing device includes a compensation circuit configured to select the compensating adjustment from at least two possible compensating adjustments in response to the sensed trembling motion. In an embodiment, the hand-held computing device includes an input circuit configured to receive a signal indicative of a user touch to the delineated touch-selectable area or to an adjusted delineated touch-selectable area. The hand-held computing device includes an application capable of running on a processor of the hand-held computing device and configured to execute an instruction associated with the displayed widget in response to the signal indicative of a user touch.

For example, and without limitation, an embodiment of the subject matter described herein includes a method. The method includes delineating a touch-selectable area on a touch-sensitive display surface of a hand-held computing device. The method includes displaying at least a portion of a widget within the delineated touch-selectable area. The method includes sensing a motion of a user appendage approaching the touch-sensitive display surface. The method includes predicting a touch-contact site on the touch-sensitive display surface of the approaching user appendage, the predicted touch-contact site at least partially based on the sensed motion. The method includes applying a compensating adjustment to the displayed widget or the delineated touch-selectable area, the compensating adjustment responsive to the predicted touch-contact site.

In an embodiment, the method includes selecting the compensating adjustment from at least two possible compensating adjustments in response to the sensed tremble motion. In an embodiment, the method includes receiving a signal indicative of a user touch to the delineated touch-selectable area or to an adjusted delineated touch-selectable area. The method also includes executing on a processor of the hand-held computing device an instruction associated with the displayed widget in response to the signal indicative of a user touch.

For example, and without limitation, an embodiment of the subject matter described herein includes a computer program product. The computer program product incudes computer-readable media bearing program instructions. The program instructions which, when executed by a processor of a mobile computing device having a touch-sensitive display surface, cause the computing device to perform a process. The process includes delineating a touch-selectable area on the touch-sensitive display surface. The process includes displaying at least a portion of a widget within the delineated touch-selectable area. The process includes sensing a motion of an approaching movement between the touch-sensitive display surface and a user appendage. The process includes predicting a touch-contact site on the touch-sensitive display surface of the approaching user appendage, the predicted touch-contact site at least partially based on the sensed motion. The process includes applying a compensating adjustment to the displayed widget in response to the predicted touch-contact site.

In an embodiment, the process includes selecting the compensating adjustment from at least two possible compensating adjustments in response to the sensed tremble motion. In an embodiment, the process includes receiving a signal indicative of a user touch to the delineated touch-selectable area or to an adjusted delineated touch-selectable area. The process also includes executing on a processor of the hand-held computing device an instruction associated with the displayed widget in response to the signal indicative of a user touch.

For example, and without limitation, an embodiment of the subject matter described herein includes a hand-held computing device having a touch-sensitive display surface. The hand-held computing device includes means for delineating a touch-selectable area on the touch-sensitive display surface. The hand-held computing device includes means for displaying a widget in a positional relationship with the delineated touch-selectable area. The hand-held computing device includes means for sensing a motion of a user appendage approaching the touch-sensitive display surface. The hand-held computing device includes means for predicting touch-contact site on the touch-sensitive display surface of the approaching user appendage, the predicted touch-contact site at least partially based on the sensed motion. The hand-held computing device includes means for applying a compensating adjustment to the displayed widget in response to the predicted touch-contact site.

In an embodiment, the hand-held computing device includes means for selecting the compensating adjustment from at least two possible compensating adjustments in response to the sensed tremble motion. In an embodiment, the hand-held computing device includes means for receiving a signal indicative of a user touch to the delineated touch-selectable area or to an adjusted delineated touch-selectable area. The hand-held computing device also includes means for executing on a processor of the hand-held computing device an instruction associated with the displayed widget in response to the signal indicative of a user touch.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example embodiment of a thin computing device in which embodiments may be implemented;

FIG. 2 illustrates an example embodiment of a general-purpose computing system in which embodiments may be implemented;

FIG. 3 illustrates an example environment 300 in which embodiments may be implemented;

FIG. 4 illustrates an embodiment of the touch-sensitive display surface 310 of the mobile computing device 302 of FIG. 3;

FIG. 5 illustrates an embodiment of the touch-sensitive display surface 310;

FIG. 6 illustrates an embodiment of the touch-sensitive display surface 310;

FIG. 7 illustrates an embodiment of the touch-sensitive display surface 310;

FIG. 8 illustrates an embodiment of the touch-sensitive display surface 310;

FIG. 9 illustrates an embodiment of the touch-sensitive display surface 310;

FIG. 10 illustrates an embodiment of the touch-sensitive display surface 310;

FIG. 11 illustrates an example operational flow 400 implemented in a mobile computing device having a touch-sensitive display surface;

FIG. 12 illustrates alternative embodiments to the example operational flow 400 of FIG. 11;

FIG. 13 illustrates an example computer program product 500;

FIG. 14 illustrates an example mobile computing device 600;

FIG. 15 illustrates an example environment 700;

FIG. 16 illustrates an example operational flow 800;

FIG. 17 illustrates an alternative embodiment to the operational flow 800 of FIG. 16;

FIG. 18 illustrates an example computer program product 900;

FIG. 19 illustrates an example hand-held computing device 1000 having a touch-sensitive display surface;

FIG. 20 illustrates an example environment 1100;

FIG. 21 illustrates an example operational flow 1200;

FIG. 22 illustrates an alternative embodiment of the operational flow 1200 of FIG. 21;

FIG. 23 illustrates a computer program product 1300; and

FIG. 24 illustrates an example hand-held computing device 1400 having a touch-sensitive display surface.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various implementations by which processes and/or systems and/or other technologies described herein can be effected (e.g., hardware, software, and/or firmware), and that the preferred implementation will vary with the context in which the processes and/or systems and/or other technologies are deployed. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Hence, there are several possible implementations by which the processes and/or devices and/or other technologies described herein may be effected, none of which is inherently superior to the other in that any implementation to be utilized is a choice dependent upon the context in which the implementation will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, module, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch-sensitive screen or display surface, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch-sensitive screen or display surface, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

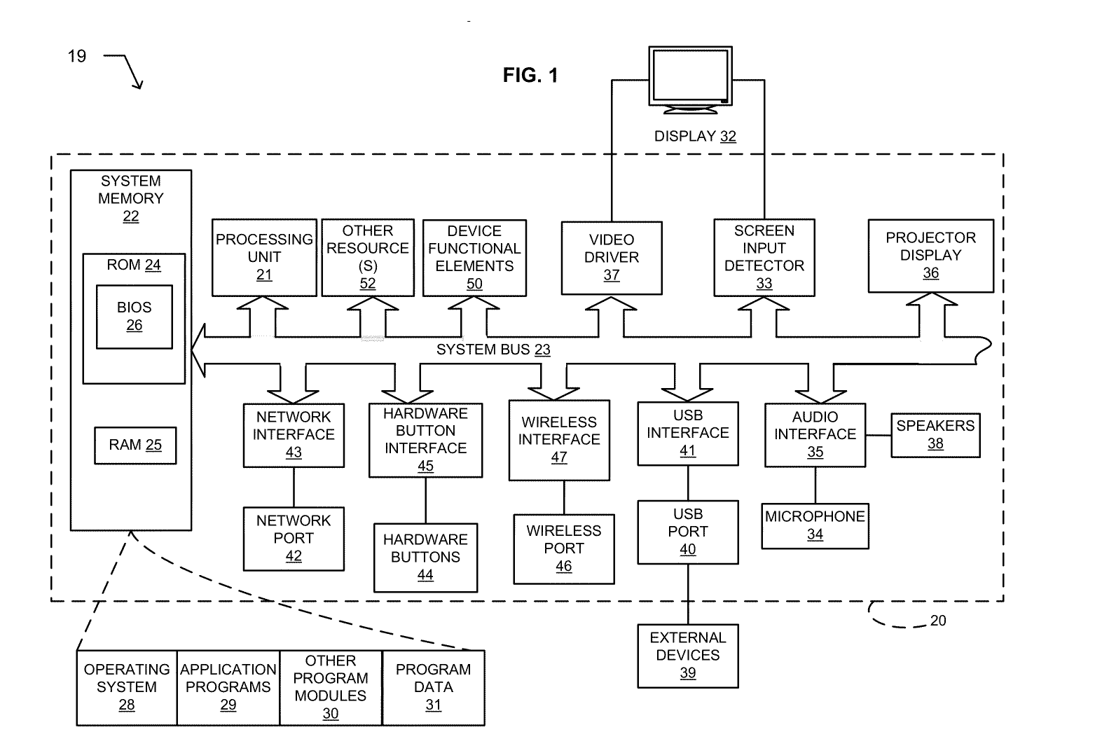

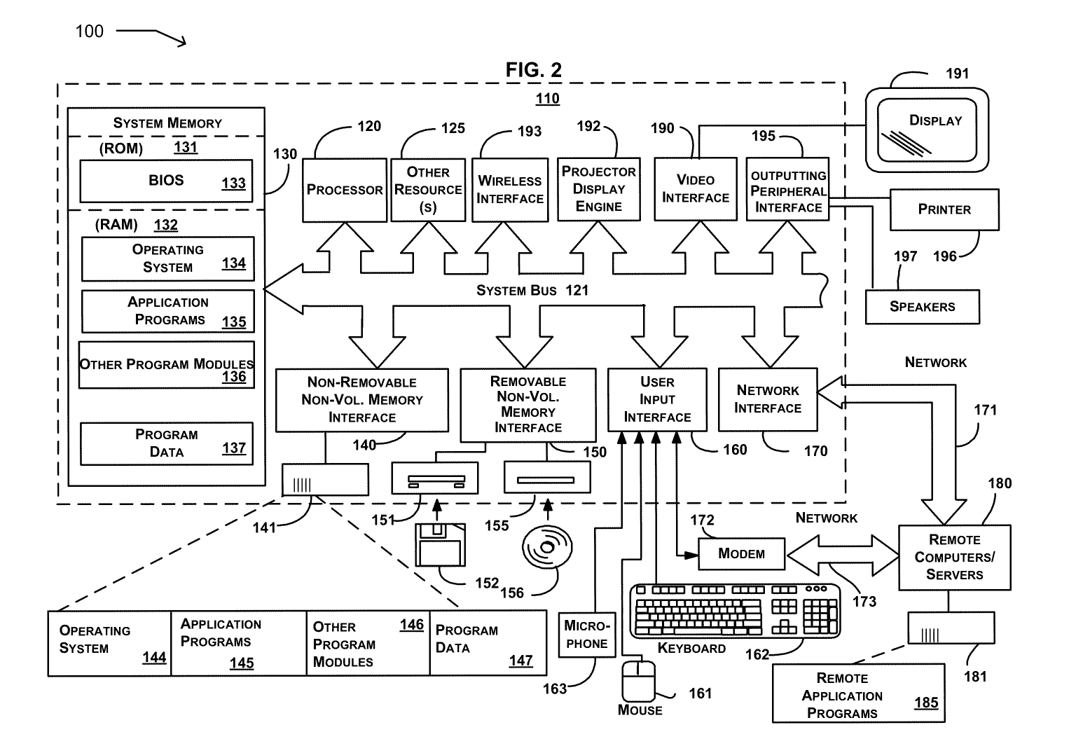

FIGS. 1 and 2 provide respective general descriptions of several environments in which implementations may be implemented. FIG. 1 is generally directed toward a thin computing environment 19 having a thin computing device 20, and FIG. 2 is generally directed toward a general purpose computing environment 100 having general purpose computing device 110. However, as prices of computer components drop and as capacity and speeds increase, there is not always a bright line between a thin computing device and a general purpose computing device. Further, there is a continuous stream of new ideas and applications for environments benefited by use of computing power. As a result, nothing should be construed to limit disclosed subject matter herein to a specific computing environment unless limited by express language.

FIG. 1 and the following discussion are intended to provide a brief, general description of a thin computing environment 19 in which embodiments may be implemented. FIG. 1 illustrates an example system that includes a thin computing device 20, which may be included or embedded in an electronic device that also includes a device functional element 50. For example, the electronic device may include any item having electrical or electronic components playing a role in a functionality of the item, such as for example, a refrigerator, a car, a digital image acquisition device, a camera, a cable modem, a printer an ultrasound device, an x-ray machine, a non-invasive imaging device, or an airplane. For example, the electronic device may include any item that interfaces with or controls a functional element of the item. In another example, the thin computing device may be included in an implantable medical apparatus or device. In a further example, the thin computing device may be operable to communicate with an implantable or implanted medical apparatus. For example, a thin computing device may include a computing device having limited resources or limited processing capability, such as a limited resource computing device, a wireless communication device, a mobile wireless communication device, a smart phone, an electronic pen, a handheld electronic writing device, a scanner, a cell phone, a smart phone (such as an Android® or iPhone® based device), a tablet device (such as an iPad®) or a Blackberry® device. For example, a thin computing device may include a thin client device or a mobile thin client device, such as a smart phone, tablet, notebook, or desktop hardware configured to function in a virtualized environment.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 or RAM 25, including an operating system 28, one or more application programs 29, other program modules 30 and program data 31.

A user may enter commands and information into the computing device 20 through one or more input interfaces. An input interface may include a touch-sensitive screen or display surface, or one or more switches or buttons with suitable input detection circuitry. A touch-sensitive screen or display surface is illustrated as a touch-sensitive display 32 and screen input detector 33. One or more switches or buttons are illustrated as hardware buttons 44 connected to the system via a hardware button interface 45. The output circuitry of the touch-sensitive display 32 is connected to the system bus 23 via a video driver 37. Other input devices may include a microphone 34 connected through a suitable audio interface 35, or a physical hardware keyboard (not shown). Output devices may include the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are examples and other components and means of establishing communication links may be used.

The computing device 20 may be primarily designed to include a user interface. The user interface may include a character, a key-based, or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and are coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, a camera capturing and saving an image, or communicating with an implantable medical apparatus.

In certain instances, one or more elements of the thin computing device 20 may be deemed not necessary and omitted. In other instances, one or more other elements may be deemed necessary and added to the thin computing device.

FIG. 2 and the following discussion are intended to provide a brief, general description of an environment in which embodiments may be implemented. FIG. 2 illustrates an example embodiment of a general-purpose computing system in which embodiments may be implemented, shown as a computing system environment 100. Components of the computing system environment 100 may include, but are not limited to, a general purpose computing device 110 having a processor 120, a system memory 130, and a system bus 121 that couples various system components including the system memory to the processor 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media. By way of further example, and not of limitation, computer-readable media may include a communication media.

Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, or atomic quantum memory. Combinations of any of the above may also be included within the scope of computer-readable media.

Communication media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media may include wired media, such as a wired network and a direct-wired connection, and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by the processor 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” ® are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, or is coupled to an optical disk drive 155 that reads from and writes to a removable, non-volatile optical disk 156, such as a CD ROM. Other removable/non-removable, volatile/non-volatile computer storage media that can be used in the example operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch-sensitive screen or display surface, joystick, game pad, satellite dish, and scanner. These and other input devices are often connected to the processor 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, or the wireless interface 193. The network may include a LAN network environment, or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on memory storage device 181. It will be appreciated that the network connections shown are examples and other means of establishing communication link between the computers may be used.

In certain instances, one or more elements of the computing device 110 may be deemed not necessary and omitted. In other instances, one or more other elements may be deemed necessary and added to the computing device.

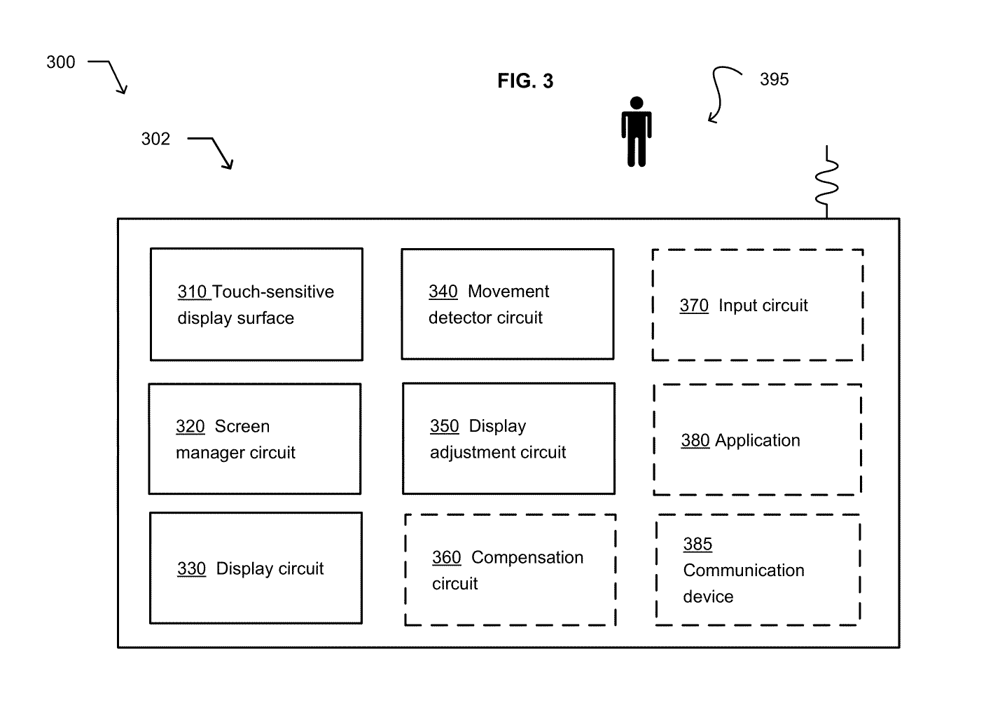

FIG. 3 illustrates an example environment 300 in which embodiments may be implemented. The environment includes a mobile computing device 302 having a touch-sensitive display surface 310. For example, the touch-sensitive display surface may be similar to the touch-sensitive display 32 described in conjunction with FIG. 1. The environment also includes a human user of the mobile computing device, illustrated as user 395. In certain instances, the user may experience a condition that results in a trembling in one or both hands.

The mobile computing device 302 includes a screen manager circuit 320 configured to delineate a touch-selectable area on the touch-sensitive display surface 310. The mobile computing device includes a display circuit 330 configured to display a widget in a positional relationship or spatial association with the delineated touch-selectable area. The mobile computing device includes a movement detector circuit 340 configured to sense a motion of the touch-sensitive display surface. The mobile computing device includes a display adjustment circuit 350 configured to apply a compensating adjustment to the displayed widget or the delineated touch-selectable area, the compensating adjustment responsive to an aspect of the sensed motion.

In an embodiment, the mobile computing device 302 may include a hand-held computing device, laptop, smart phone, tablet, or computing device mounted in mobile chassis. In an embodiment, the mobile computing device may be carried by a chassis of a mobile vehicle, such as a car, boat, or aircraft. In an embodiment, the mobile computing device may include a cellular phone, wireless music player, video player, netbook, laptop computer, e-reading device, tablet computer, camera, calculator, controller, remote control, analytic device, or other mobile computing device. In an embodiment, the mobile computing device may be implemented in part or whole using the general purpose thin computing device 20 described in conjunction with FIG. 1. In an embodiment, the mobile computing device may be implemented in part or whole using the general purpose computing device 100 described in conjunction with FIG. 2.

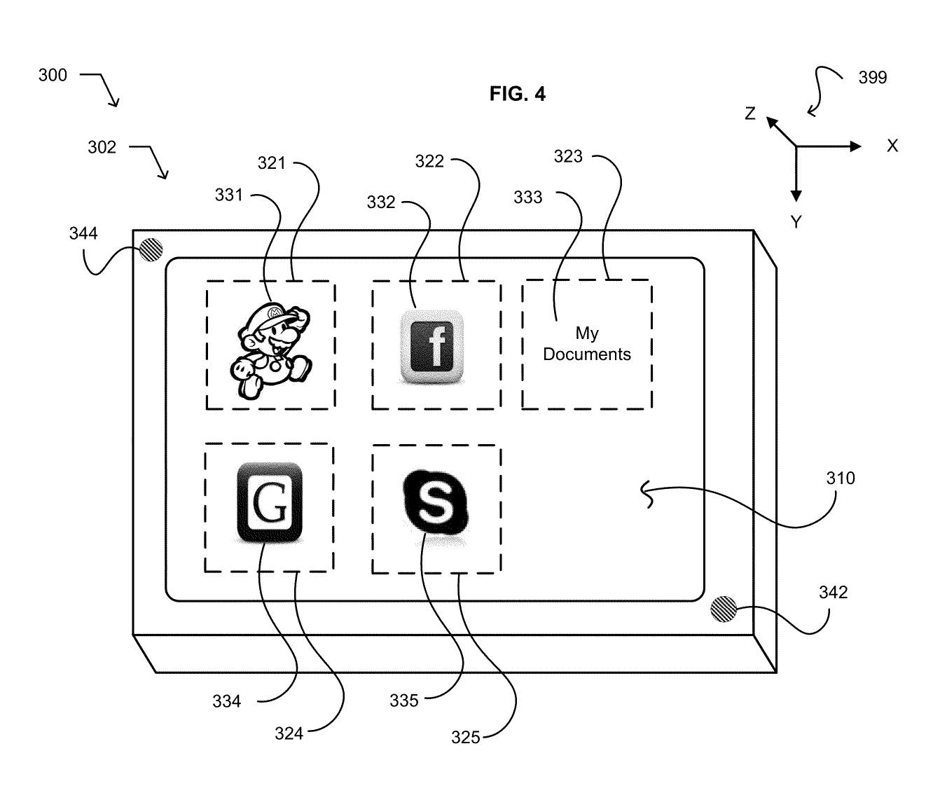

FIG. 4 illustrates an embodiment of the touch-sensitive display surface 310 of the mobile computing device 302 of FIG. 3. The display surface and the mobile computing device is illustrated with respect to an X-Y-Z axis 399. The illustrated embodiment includes touch-selectable areas 321-325 delineated on the touch-sensitive display surface. The illustrated embodiment also includes widgets 331-335 displayed in a positional relationship or spatial association with the delineated touch-selectable areas 321-325. The illustrated embodiment includes sensors 342 and 344 of the movement detector circuit 340 described in conjunction with FIG. 3. For example, in an embodiment, sensor 342 may be configured to sense a proximity and/or a movement or motion of a user appendage to the touch-sensitive display surface. For example, in an embodiment, sensor 342 may be configured to a proximity and/or a movement or motion of a user appendage, by using a camera, a radar, or an ultrasonic imager carried by the mobile computing device. In an embodiment, the proximity or motion may be at least partially determined through use of an active or passive component attached to the user appendage; for example, this may include a retroreflector, a magnetic field or magnetic detector, an electric field source, an ultrasonic transducer beacon or a light source. For example, in an embodiment, sensor 344 may be configured to sense a movement of the touch-sensitive display surface, by using an accelerometer or gyroscope carried by the mobile computing device.

A widget includes an element of a graphical user interface (GUI) that displays information or provides a specific way for a user to interact with the operating system and application. For example, FIG. 4 illustrates examples of widgets in a positional relationship or spatial association with a delineated touch-selectable area, such as widget 331 in a positional relationship or spatial association with a delineated touch-selectable area 321. Continuing with FIGS. 3 and 4, in an embodiment, widgets include icons, pull-down menus, buttons, selection boxes, progress indicators, on-off checkmarks, scroll bars, windows, window edges (that let you resize the window), toggle buttons, forms, and many other devices for displaying information and for inviting, accepting, and responding to user actions. In an embodiment, an icon includes a small picture or symbol of a graphical user interface that represents a program (or command), file, directory (also called a folder), device (such as a hard disk or floppy), or user options. In an embodiment, a widget represents an activatable user control. In an embodiment, a widget facilitates a specific user-computer interaction. In an embodiment, a widget when selected by a user activates a particular user control of the mobile computing device 302. In an embodiment, the widget and the delineated touch-selectable area are elements of a graphical user interface. In an embodiment, a widget includes a post-wimp interface. In an embodiment, a widget includes an element of a virtual touchpad or touch panel. In an embodiment, a widget includes a selectable widget from among a plurality of selectable widgets. In an embodiment, the widget includes an adjustable feature or aspect, such as an adjustable size, resolution, shape, position, location, brightness, or visual relationship relative to touch-selectable area. In an embodiment, the widget includes an adjustable feature or aspect, such as shadowing or ghosting. In an embodiment, a widget provides a visual hint, suggestion, or indication of an action that will be initiated by a computing device in response to a touch.

In an embodiment, the touch-sensitive display surface 310 may include a touch-sensitive display surface using capacitive sensors, resistive sensors, or active digitizers. In an embodiment, the touch-sensitive display surface may be limited to detecting only single touches by a user stylus or a user finger. In an embodiment, the touch-sensitive display surface may be capable of sensing multiple simultaneous touches. In an embodiment, the touch-sensitive display includes a 3-D display having a touch-sensitive surface.

In an embodiment, the screen manager circuit 320 is configured to delineate a touch-selectable area at a first particular region on the touch-sensitive display surface 310. In an embodiment, the screen manager circuit is configured to delineate a touch-selectable area at a first particular location and encompassing a first region of the real estate of the touch-sensitive display surface. In an embodiment, the screen manager circuit is configured to delineate a first touch-selectable area at a first region of the real estate of the touch-sensitive display surface and a second touch-selectable area at a second region of the real estate of the touch-sensitive display surface on the touch-sensitive display surface.

In an embodiment, the movement detector circuit 340 is configured to sense a motion of the touch-sensitive display surface 310 imparted by a user holding the mobile computing device. In an embodiment, the movement detector circuit is configured to generate a signal indicative of a user-imparted motion of the touch-sensitive display surface. In an embodiment, the movement detector circuit is configured to sense a motion of the touch-sensitive display surface imparted by involuntary movements, tremors, or actions of a user holding the mobile computing device. In an embodiment, the movement detector circuit is configured to sense a motion of the touch-sensitive display surface imparted by a motion of a chassis carrying the mobile computing device. In an embodiment, the movement detector circuit is configured to generate a signal indicative of a motion of the touch-sensitive display surface relative to the earth. In an embodiment, the movement detector circuit is configured to generate a signal indicative of a motion of the touch-sensitive display surface relative to an inertial reference frame. In an embodiment, the movement detector circuit is configured to generate a signal indicative of a motion of the touch-sensitive display surface relative to an axis of the touch-sensitive display surface. For example, the motion of the touch-sensitive display surface may include a linear or a rotational motion. In an embodiment, the movement detector circuit is configured to generate a signal indicative of a motion of the touch-sensitive display surface relative to two axis of the touch-sensitive display surface. For example, the movement detector circuit may include a dual axis gyroscope. In an embodiment, the movement detector circuit is configured to generate a signal indicative of a motion of the touch-sensitive display surface relative to three axis of the touch-sensitive display surface. In an embodiment, the movement detector circuit includes a gyroscope, micro-machined gyroscope, motion sensor, or accelerometer configured to sense a motion of the touch-sensitive display surface. In an embodiment, the movement detector circuit includes a movement detector circuit configured to sense a change in position, velocity, or acceleration of the touch-sensitive surface.

In an embodiment, the movement detector circuit 340 is further configured to filter the sensed motion at least partially based on its time dependences. For example, the filtering may reduce or remove slowly occurring motions relative to fast occurring motions. For example, the filtering may reduce or remove slow or gestural movements caused by normal movement components and result in the sensed motion corresponding to a tremble movement component of a hand holding the mobile computing device 302. For example, the filtering may reduce or remove fast occurring movements caused by tremble movements, and result in the sensed motion corresponding to user-purposeful or user-intentional slow or gestural movements of a hand holding the mobile computing device. For example, the filtering may reduce or remove all sensed movements except the most recent one second, most recent two seconds, most recent five seconds, etc. In an embodiment, the movement detector circuit is further configured to filter the sensed motion at least partially based on a size or magnitude of the sensed motion. For example, the movement detection circuit may not sense, may filter out, or may neglect a motion below a threshold parameter. This prevents chasing micro-motions. Alternatively, in an embodiment, the movement detection circuit may neglect or attenuate a response to large scale motions. In an embodiment, the movement detection circuit is further configured to extract from the sensed motion a user-imparted tremble motion component to the touch-sensitive display surface. In an embodiment, the movement detector circuit is further configured to extract from the sensed motion a user-purposeful or user-intentional motion component to the touch-sensitive display surface.

In an embodiment, a tremor, a tremble, a tremble motion, or a trembling motion (collectively referred to herein from time to time as a tremble or tremble motion) may include an involuntary shudder, shaking, vibration, trembling, or quivering movement. For example, a tremble may include an involuntary shaking or trembling of the head or extremities that can be idiopathic or associated with any of various medical conditions, such as Parkinson's disease. For example, a tremble motion may be described as involuntary, somewhat rhythmic (4-12 Hz), muscle contraction and relaxation involving to-and-fro movements, oscillations or twitching, of one or more body parts. It can affect the hands, arms, eyes, face, head, vocal cords, trunk, and legs. A tremble most commonly affects the hands, which may be used for holding a mobile computing device or selecting a widget on a touch screen of a mobile computing device. Trembles are associated with disorders in the parts of the brain that control muscles. There are a multitude of conditions that have trembling as a symptom such as multiple sclerosis, traumatic brain injury, stroke, neurodegenerative diseases from which Parkinson's disease is the one most associated with trembles. They can also be caused by lack of sleep, stress, consumption of drugs, alcohol or tobacco. A tremble may be classified by the way it manifests its self and by its cause. The most common types of tremble are:
intentional tremble, which is characterized by a slow broad tremble that appears at towards the end of an intentional action or movement, like picking up a spoon or pressing a button. Intention tremble is commonly associated with multiple sclerosis; an estimate of 75% of the sufferers from multiple sclerosis will suffer from tremble at one point.
dystonic tremble, it is a tremble that affects people of all ages and involves involuntary muscle contractions causing twisting and repetitive motion and can be painful.
essential tremble, is the most common disorder among the people suffering from tremble, it is characterized by tremble that occur during an action. It affects the hands mostly but other body parts can be also affected. About 4% of people around the age of 40 are affected by essential tremble, the percentage increases as people get older, at the age of 60 about 14% of people are suffering.
Parkinsonian tremble is caused by the Parkinson's disease and it is a resting type of tremble, it appears after an action has been performed and will stop as soon as another action starts. Parkinson's disease affects 1-2% of the population over the age of 60.

In an embodiment, the mobile computing device 302 further includes a compensation circuit 360 configured to select the compensating adjustment from at least two possible compensating adjustments. In an embodiment, the compensation circuit is configured to select the compensating adjustment in response to predicted motion of the touch-sensitive display surface. The predicted motion is at least partially based on the sensed motion of the touch-sensitive display surface. The prediction may be based upon forward integration of sensed velocity or acceleration motions. The prediction may be based on smoothing or filtering of the sensed motion. The prediction may be based on model-based filtration, such as Kalman filters, or maximum-likelihood filters, of the sensed motion.

In an embodiment, the compensating adjustment includes an adjustment counteracting the sensed motion of the touch-sensitive display. In an embodiment, the compensating adjustment includes moving the widget or the delineated touch-selectable area with an acceleration counteracting an acceleration component of the sensed motion. For example, using acceleration is expected to reduce the effect of any spatial drift movement that may be occurring.

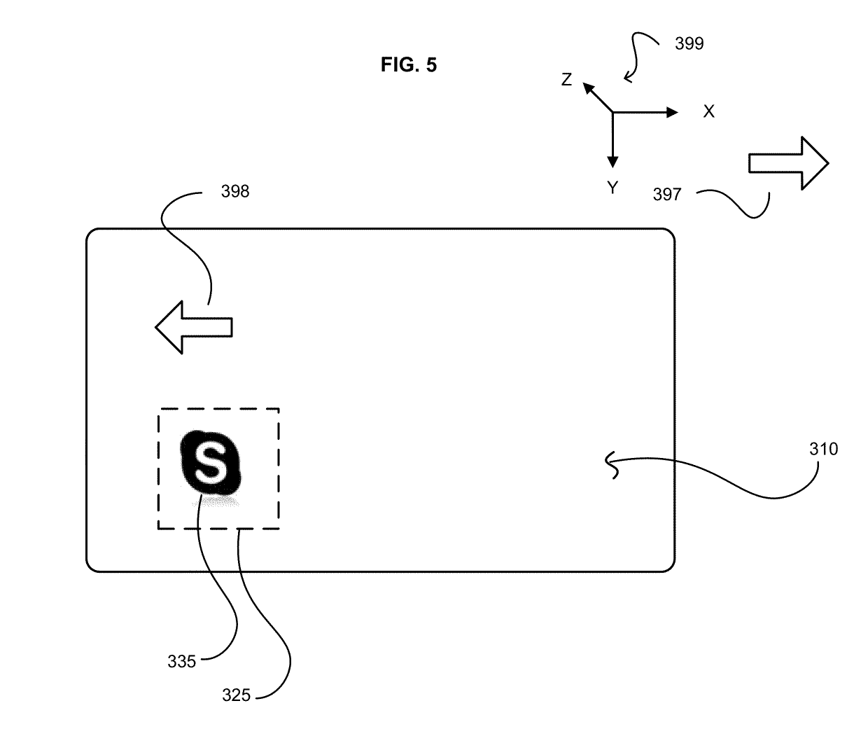

FIG. 5 illustrates an embodiment of the touch-sensitive display surface 310. In the illustrated embodiment, the touch-sensitive display surface illustrated in FIG. 4 experiences a motion 397 along the X axis of the X-Y-Z axis 399. In an embodiment, a compensating adjustment to the widget 335 and the delineated touch-selectable area 325 on the touch-sensitive display surface includes establishing a counteracting positional relationship between the widget and the delineated touch-selectable area. FIG. 5 illustrates the counteracting positional relationship as including moving both the widget 335 and the delineated touch-selectable area 325 in a counteraction direction 398 along the X axis. For clarity, the other widgets and delineated touch-selectable areas of FIG. 4 are not included in FIG. 5. While this and subsequent discussion refers to a single component (e.g., along the X axis), the motion and counteracting positional relationship may be along the Y axis, or may involve motion components along both the X and Y axis.

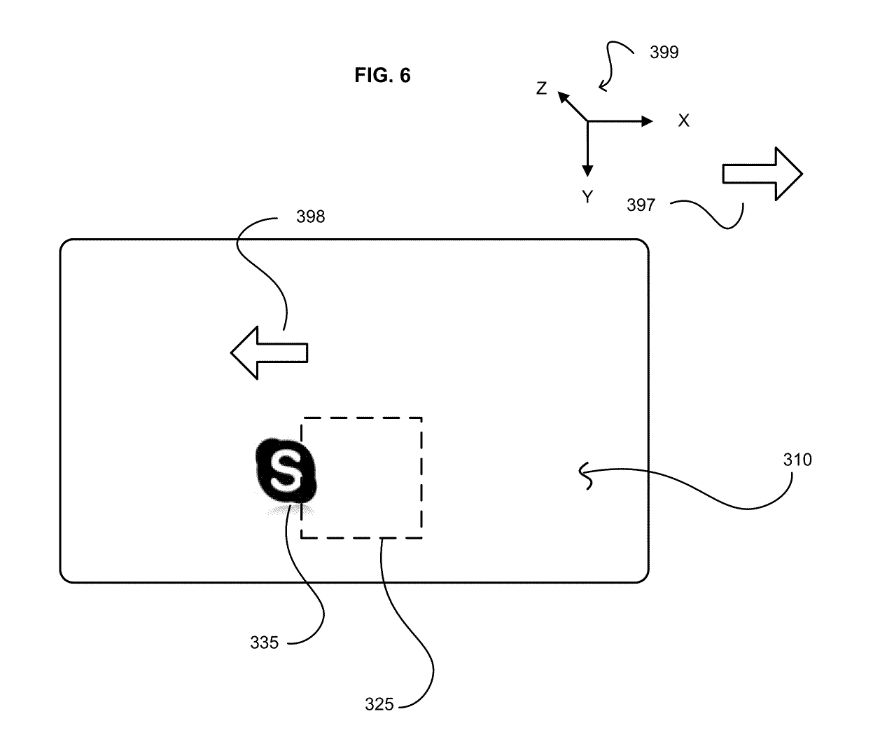

FIG. 6 illustrates an embodiment of the touch-sensitive display surface 310. In the illustrated embodiment, the touch-sensitive display surface illustrated in FIG. 4 experiences a motion 397 along the X axis of the X-Y-Z axis 399. In an embodiment, a compensating adjustment includes repositioning the displayed widget with respect to the delineated touch-selectable area. FIG. 6 illustrates the counteracting positional relationship as including repositioning the displayed widget 335 in a counteraction direction 398 along the X axis with respect to the delineated touch-selectable area 325.

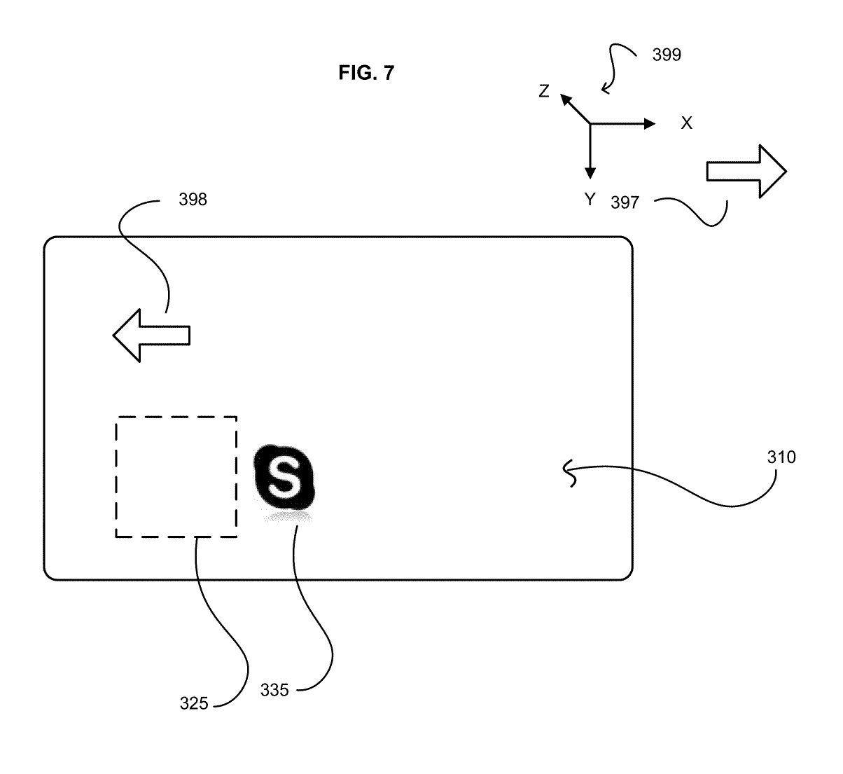

FIG. 7 illustrates an embodiment of the touch-sensitive display surface 310. In the illustrated embodiment, the touch-sensitive display surface illustrated in FIG. 4 experiences a motion 397 along the X axis of the X-Y-Z axis 399. In an embodiment, a compensating adjustment includes repositioning the delineated touch-selectable area with respect to the displayed widget. FIG. 7 illustrates the counteracting positional relationship as including repositioning the delineated touch-selectable area 325 in a counteraction direction 398 along the X axis with respect to the displayed widget 335.

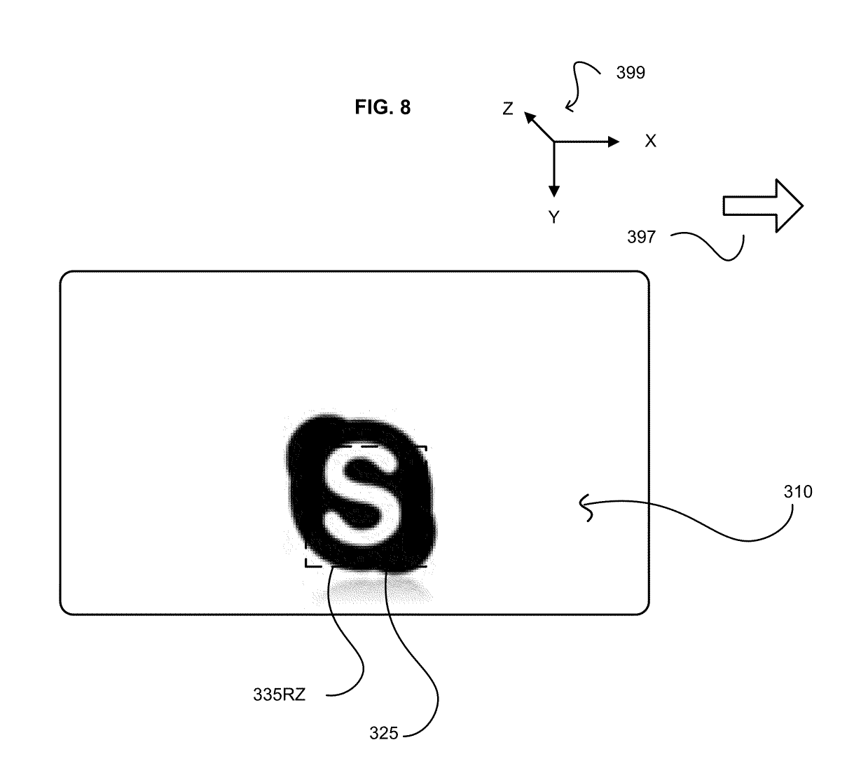

FIG. 8 illustrates an embodiment of the touch-sensitive display surface 310. In the illustrated embodiment, the touch-sensitive display surface illustrated in FIG. 4 experiences a motion 397 along the X axis of the X-Y-Z axis 399. In an embodiment, a compensating adjustment includes resizing the widget. FIG. 8 illustrates the compensating adjustment as including resizing the displayed widget, illustrated as resized or enlarged widget 335RZ. The resizing may be symmetric, or may be involve a preferential stretching in a direction opposing the motion 397.

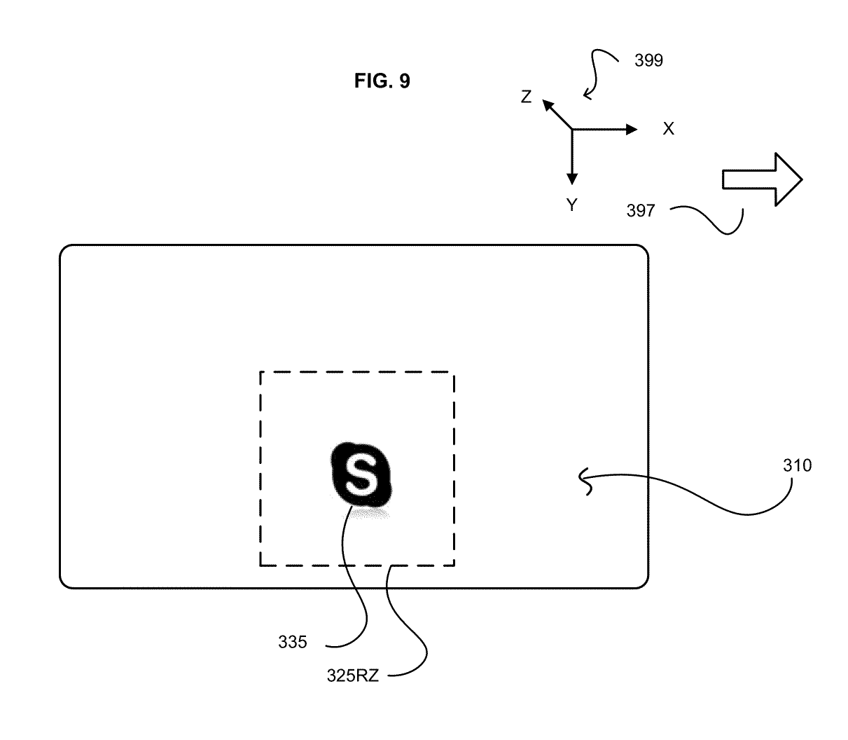

FIG. 9 illustrates an embodiment of the touch-sensitive display surface 310. In the illustrated embodiment, the touch-sensitive display surface illustrated in FIG. 4 experiences a motion 397 along the X axis of the X-Y-Z axis 399. In an embodiment, a compensating adjustment includes resizing the delineated touch-selectable area. FIG. 9 illustrates the compensating adjustment as including resizing the delineated touch-selectable area, illustrated as resized or enlarged widget 325RZ. The resizing may be symmetric, or may be involve a preferential stretching in a direction opposing the motion 397.

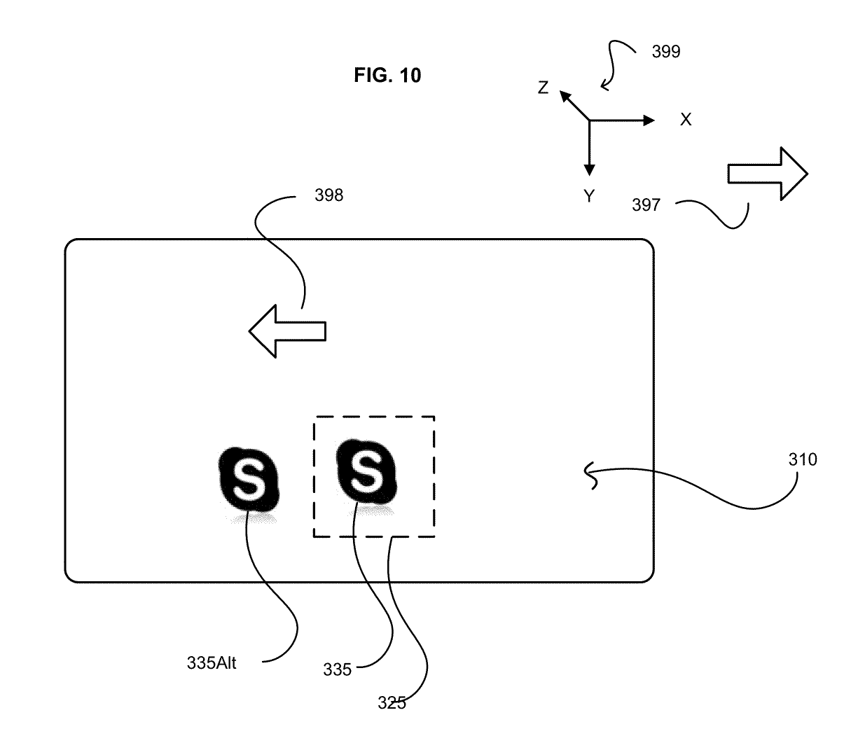

FIG. 10 illustrates an embodiment of the touch-sensitive display surface 310. In the illustrated embodiment, the touch-sensitive display surface illustrated in FIG. 4 experiences a motion 397 along the X axis of the X-Y-Z axis 399. In an embodiment, a compensating adjustment to the widget 335 and the delineated touch-selectable area 325 on the touch-sensitive display surface includes co-displaying the widget at the positional relationship to the delineated touch-selectable area and another version of the widget at a motion compensated positional relationship to the delineated touch-selectable area. FIG. 10 illustrates the compensating adjustment as including co-displaying the widget 335 at the positional relationship to the delineated touch-selectable area 325 and another version of the widget 335Alt at a motion compensated positional relationship to the delineated touch-selectable area in a counteraction direction 398 along the X axis. In an embodiment, the co-displaying includes simultaneously displaying the widget and the another version of the widget. In an embodiment, the co-displaying includes alternately displaying the widget and the another version of the widget. In an embodiment, the co-displaying includes displaying the widget and a visually differentiated version of the widget.

Continuing with FIGS. 3 and 4, in an embodiment, the compensating adjustment includes a ghost, grayed out, or shaded version of the widget. In an embodiment, the compensating adjustment includes making at least two of the widgets larger. For example, the delineated touch-selectable areas may stay the same size, but the size of at least two of the widgets may be increased, or decreased. In an embodiment, the compensating adjustment includes dynamically reshaping the widget. In an embodiment, the compensating adjustment includes an animated version of the widget. In an embodiment, the compensating adjustment includes dynamically moving the delineated touch-selectable area while leaving the widget unchanged. In an embodiment, compensating adjustment includes displaying the widget using primarily one color and displaying another version of the widget using primarily another color. In an embodiment, the co-displaying includes displaying the widget using a first transparency and displaying another version of the widget using a second transparency. In an embodiment, the co-displaying includes steadying the displayed widget relative to an inertial reference. In an embodiment, the co-displaying includes steadying the displayed widget relative to a chassis carrying the mobile computing device. In an embodiment, the compensating adjustment includes projecting a compensated 3-D motion of the displayed widget on the display surface; this can comprise the 2-D component of the 3-D motion which is within the plane of the display surface. In an embodiment, the compensating adjustment includes projecting a compensated 3-D motion of the displayed widget onto a depth axis of a 3-D display surface; this can comprise the component of the 3-D motion which is perpendicular to the plane of the display surface.

In an embodiment, the display adjustment circuit 350 is configured to apply a compensating adjustment to both the displayed widget and the delineated touch-selectable area. The compensating adjustment is responsive to an aspect of the sensed motion.

In an embodiment, the mobile computing device further includes an input circuit 370 configured to receive a signal indicative of a user touch to the delineated touch-selectable area or to the adjusted delineated touch-selectable area. For example the user touch may include a user touch by a finger or inanimate object such as a stylus. In this embodiment, the mobile computing device further includes an application 380 capable of running on a processor of the mobile computing device and configured to execute an instruction associated with the displayed widget in response to the signal indicative of a user touch.

In an embodiment, the mobile computing device further includes the communication device 385. The communication device includes circuitry configured to communicate with other computing devices or networks using wirelessly or wired links.

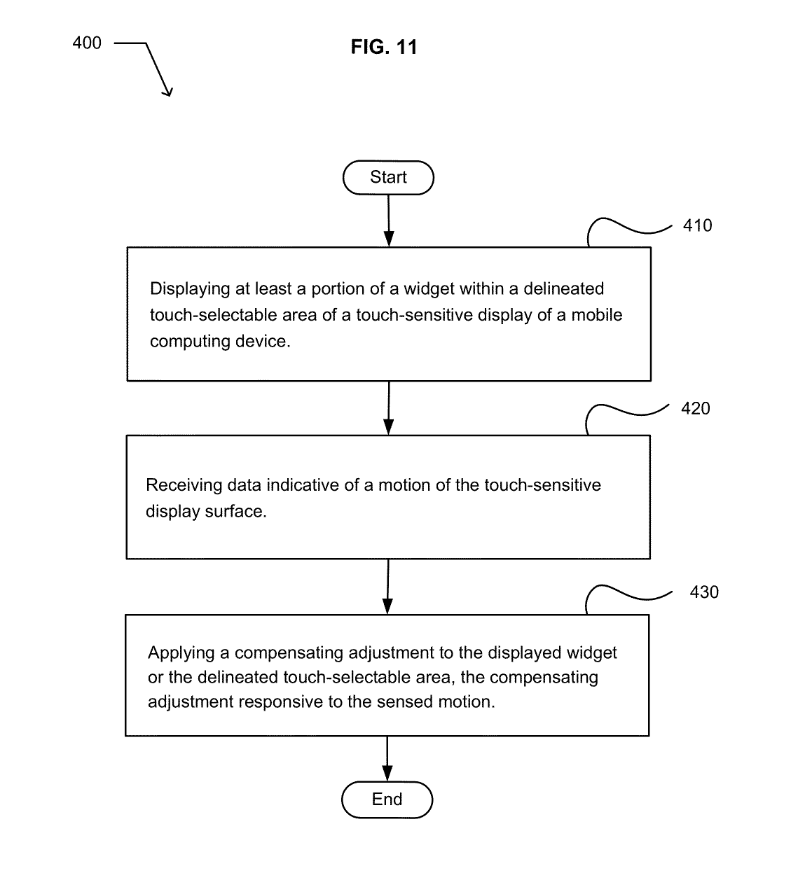

FIG. 11 illustrates an example operational flow 400 implemented in a mobile computing device having a touch-sensitive display surface. After a start operation, the operational flow includes an interface layout operation 410. The interface layout operation 410 includes displaying at least a portion of a widget within a delineated touch-selectable area of the touch-sensitive display. In an embodiment, the interface layout operation may be implemented using the display circuit 330 described in conjunction with FIG. 3. A data operation 420 includes receiving data indicative of a motion of the touch-sensitive display surface. In an embodiment, the data operation may receive data generated by the movement detector circuit 320 described in conjunction with FIG. 3. A motion compensation operation 430 includes applying a compensating adjustment to the displayed widget or the delineated touch-selectable area. The compensating adjustment is responsive to the sensed motion. In an embodiment, the motion compensation operation 430 may be implemented using the display adjustment circuit 350 described in conjunction with FIG. 3. The operational flow includes an end operation.

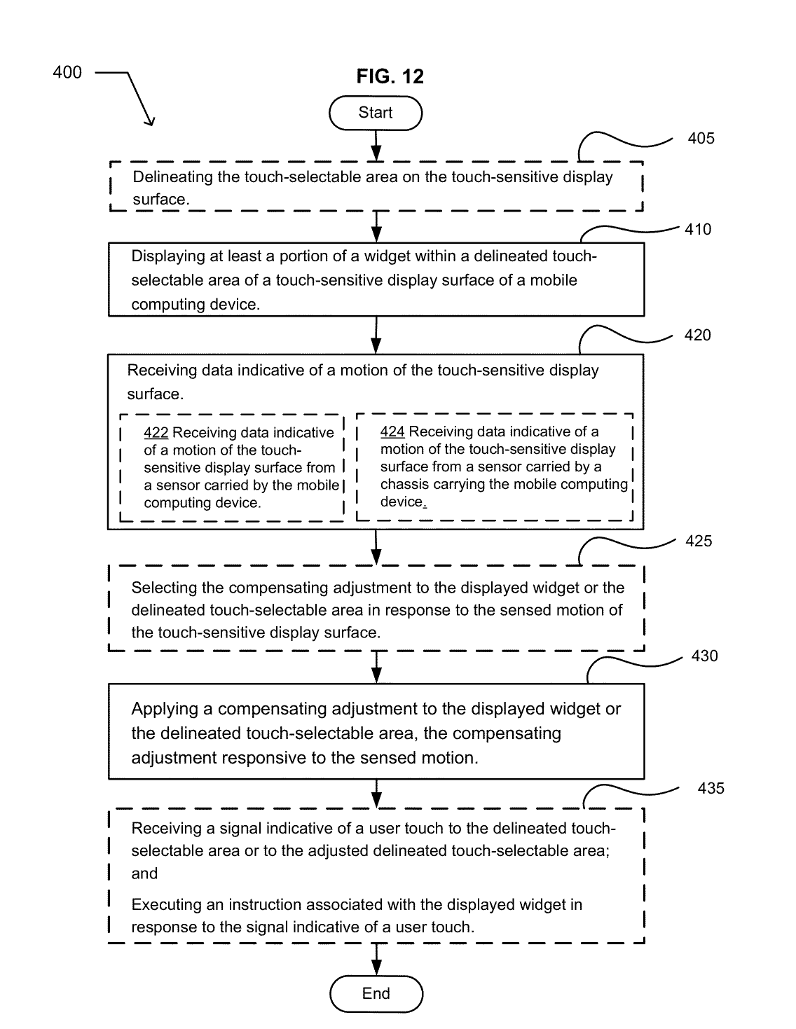

FIG. 12 illustrates alternative embodiments to the example operational flow 400 of FIG. 11. The data operation 420 may include at least one additional embodiment. The at least one additional embodiment may include an operation 422 or an operation 424. The operation 422 includes receiving data indicative of a motion of the touch-sensitive display surface from a sensor carried by the mobile computing device. The operation 424 includes receiving data indicative of a motion of the touch-sensitive display surface from a sensor carried by a chassis carrying the mobile computing device. The operational flow may include at least one additional operation. The at least one additional operation may include an operation 405, an operation 425, or an operation 435. The operation 405 includes delineating the touch-selectable area on the touch-sensitive display surface. The operation 425 includes selecting the compensating adjustment to the displayed widget or the delineated touch-selectable area in response to the sensed motion of the touch-sensitive display surface. The operation 435 includes receiving a signal indicative of a user touch to the delineated touch-selectable area or to the adjusted delineated touch-selectable area. For example, the user touch may include a finger touch or a stylus touch. The operation 435 also includes executing an instruction associated with the displayed widget in response to the signal indicative of a user touch.

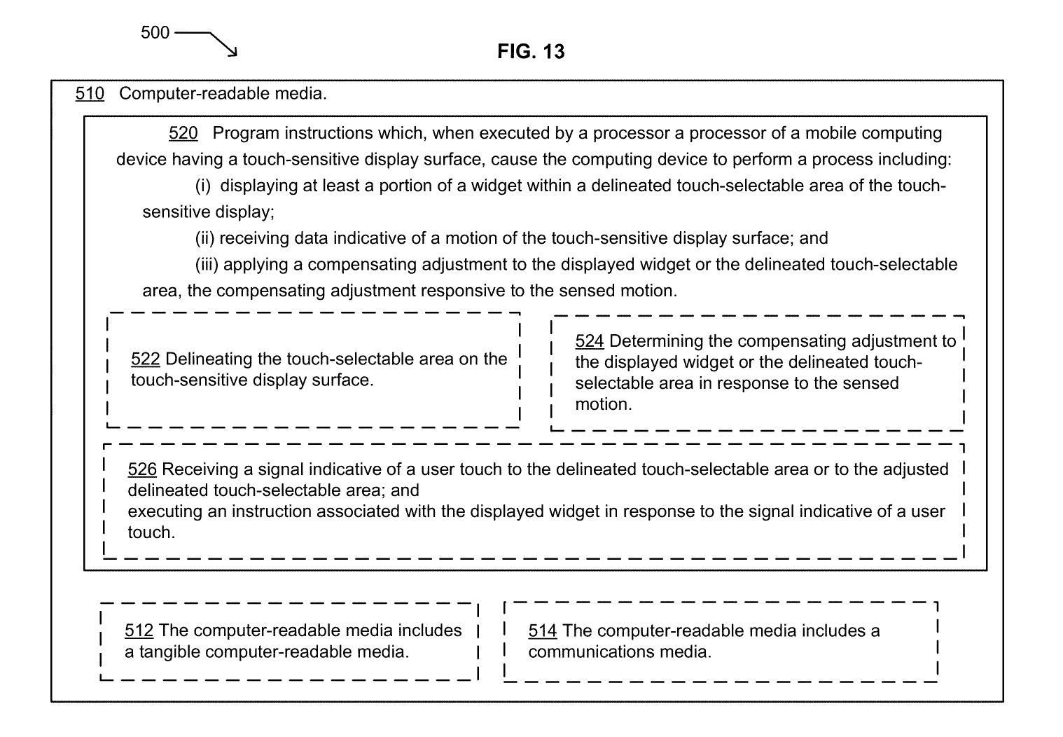

FIG. 13 illustrates an example computer program product 500. The computer program product includes computer-readable media 510 bearing program instructions. The program instructions 520 which, when executed by a processor of a mobile computing device having a touch-sensitive display surface, cause the computing device to perform a process. The process includes displaying at least a portion of a widget within a delineated touch-selectable area of the touch-sensitive display. The process includes receiving data indicative of a motion of the touch-sensitive display surface. The process includes applying a compensating adjustment to the displayed widget or the delineated touch-selectable area. The compensating adjustment is responsive to the sensed motion.

In an embodiment, the program instructions 520 may include at least one additional process. The program instructions may include a process 522 delineating the touch-selectable area on the touch-sensitive display surface. The program instructions may include a process 524 determining the compensating adjustment to the displayed widget or the delineated touch-selectable area in response to the sensed motion. The program instructions may include a process 526 receiving a signal indicative of a user touch to the delineated touch-selectable area or to the adjusted delineated touch-selectable area; and executing an instruction associated with the displayed widget in response to the signal indicative of a user touch.

In an embodiment, the computer-readable media 510 includes a tangible computer-readable media 512. In an embodiment, the computer-readable media includes a communication media 514.

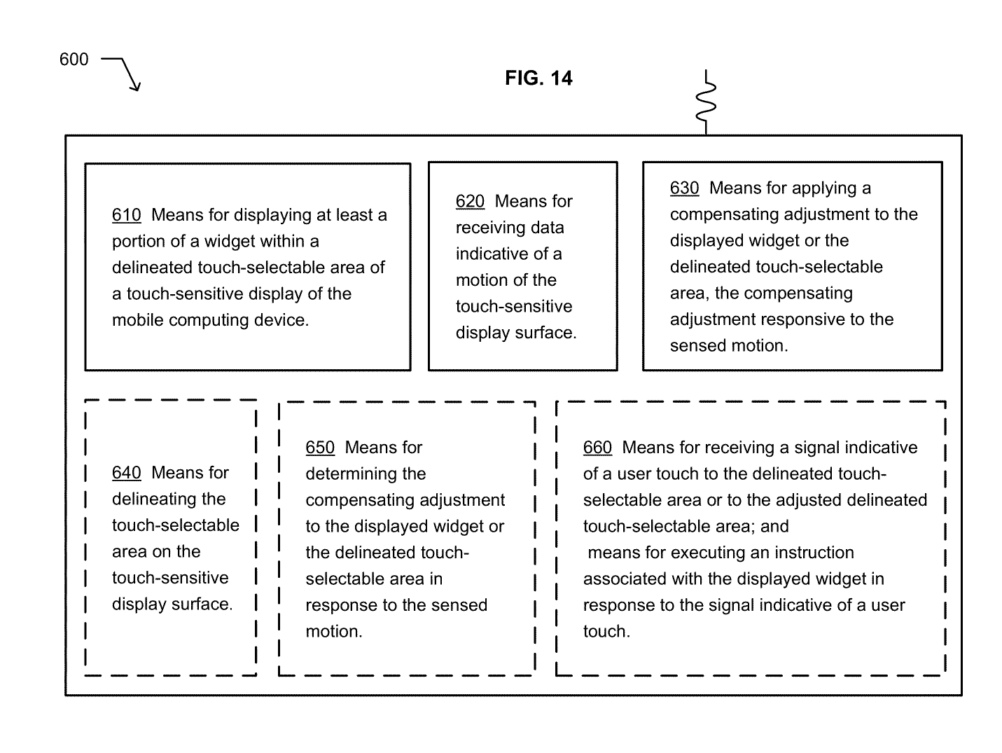

FIG. 14 illustrates an example mobile computing device 600. The mobile computing device includes means 610 for displaying at least a portion of a widget within a delineated touch-selectable area of a touch-sensitive display of the mobile computing device. The mobile computing device includes means 620 for receiving data indicative of a motion of the touch-sensitive display surface. The mobile computing device includes means 630 for applying a compensating adjustment to the displayed widget or the delineated touch-selectable area. The compensating adjustment is responsive to the sensed motion.

In an alternative embodiment, the mobile computing device 600 includes means 640 for delineating the touch-selectable area on the touch-sensitive display surface. In an alternative embodiment, the mobile computing device includes means 650 for determining the compensating adjustment to the displayed widget or the delineated touch-selectable area in response to the sensed motion. In an alternative embodiment, the mobile computing device incudes means 660 for receiving a signal indicative of a user touch to the delineated touch-selectable area or to the adjusted delineated touch-selectable area; and means for executing an instruction associated with the displayed widget in response to the signal indicative of a user touch.

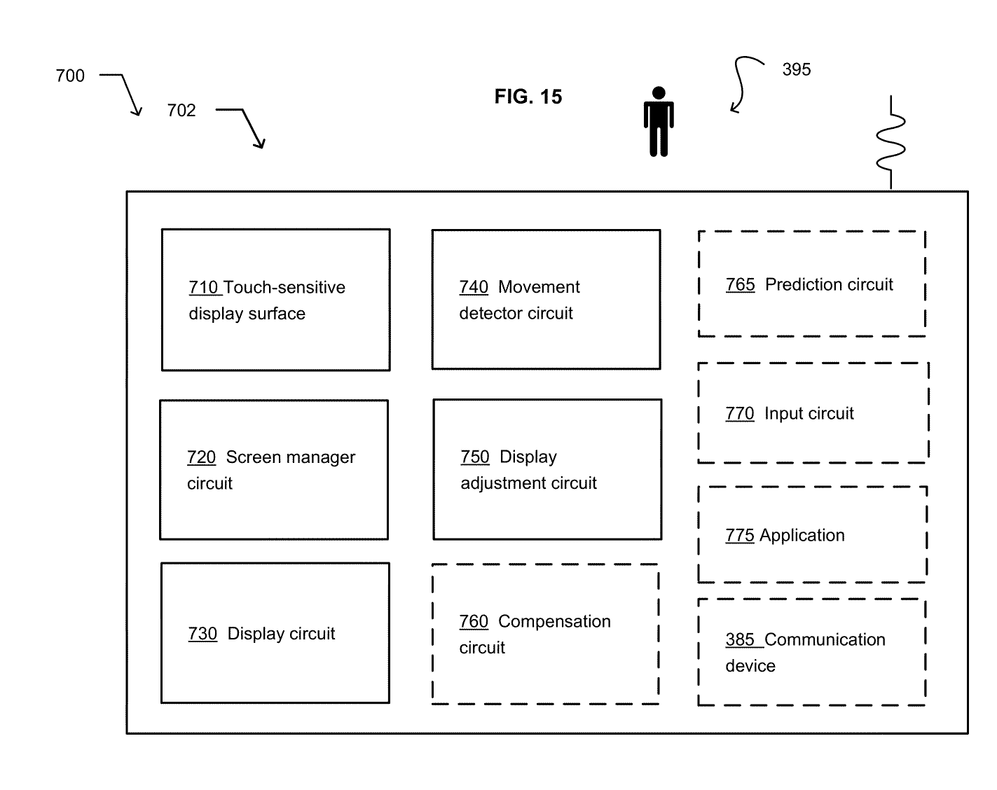

FIG. 15 illustrates an example environment 700. The example environment includes the user 395 and a hand-held computing device 702 having a touch-sensitive display surface 710. The hand-held computing device includes a screen manager circuit 720 configured to delineate a touch-selectable area on the touch-sensitive display surface. For example, the delineated touch-selectable area may include the touch-selectable area 325 described in conjunction with FIG. 4. The hand-held computing device includes a display circuit 730 configured to display at least a portion of a widget within the delineated touch-selectable area. For example, the widget may include the widget 335 described in conjunction with FIG. 4. The hand-held computing device includes a movement detector circuit 740 configured to sense a motion between the touch-sensitive display surface and a user appendage approaching the touch-sensitive display surface. The hand-held computing device includes a display adjustment circuit 750 configured to apply a compensating adjustment to the displayed widget or the delineated touch-selectable area, the compensating adjustment responsive to the sensed motion. In an embodiment, the user appendage includes a finger of the user or a stylus held by the user. In an embodiment, the hand-held computing device may be implemented in part or whole using the general purpose thin computing device 20 described in conjunction with FIG. 1. In an embodiment, the hand-held computing device may be implemented in part or whole using the general purpose computing device 100 described in conjunction with FIG. 2.

In an embodiment, the movement detector circuit 740 is configured to sense a relative motion between the touch-sensitive display surface and a user appendage approaching the touch-sensitive display surface. In an embodiment, the movement detector circuit is configured to sense an incoming motion component of a user appendage approaching the touch-sensitive display surface. In an embodiment, the incoming motion includes a user tremble motion component of the incoming motion component. In an embodiment, the incoming motion includes a user-purposeful or user-intentional motion component of the incoming motion component. In an embodiment, the movement detector circuit further includes a display-surface movement detector circuit configured to sense a motion of the touch-sensitive display surface imparted by a user holding the hand-held computing device. In an embodiment, the imparted motion includes a user-imparted tremble motion component to the touch-sensitive display surface. In an embodiment, the imparted motion includes a user-purposeful or user-intentional motion component to the touch-sensitive display surface. In an embodiment, the movement detector circuit is configured to (i) sense a motion between the touch-sensitive display surface and a user appendage approaching the touch-sensitive display surface sense; and (ii) determine the user-purposeful or user-intentional motion component of the sensed motion. For example, the movement detector may filler out a user-imparted tremble motion component.

In an embodiment, the display adjustment circuit 750 is configured to apply a compensating adjustment to both the displayed widget and the delineated touch-selectable area. The compensating adjustment is in response to either or both the user-purposeful or user-intentional motion component of the sensed motion or to a user-imparted tremble motion component of the sensed motion.

In an embodiment, the hand-held computing device 702 further includes a compensation circuit 760 configured to select the compensating adjustment from at least two possible compensating adjustments. In an embodiment, the compensation circuit is configured to select the compensating adjustment from at least two possible compensating adjustments in response to the user-purposeful or user-intentional motion component. For example, the user-purposeful or user-intentional motion component may be extracted from the sensed motion based upon a frequency component of the sensed motion, on a smoothing of the sensed motion, a size of the sensed motion, or rejection of most recent motions. In an embodiment, the compensation circuit is configured to select the compensating adjustment from at least two possible compensating adjustments in response to a sensed user-purposeful or user-intentional trajectory motion of a user appendage approaching the touch-sensitive display surface. In an embodiment, the compensation circuit is configured to select the compensating adjustment from at least two possible compensating adjustments. The selection is in response to the sensed motion of the touch-sensitive display surface and the sensed user-purposeful or user-intentional motion component of the sensed motion of a user appendage approaching the touch-sensitive display surface. In an embodiment, the compensation circuit is configured to select the compensating adjustment from at least two possible compensating adjustments. The selection is in response to a predicted motion between the touch-sensitive display surface and the user appendage approaching the touch-sensitive display surface, the predicted motion at least partially based on the sensed motion. For example, the predicted motion may include predicting a touch-screen impact site. In an embodiment, the selected compensating adjustment includes increasing a displayed size of the widget and decreasing a displayed size of another widget proximate to the widget.

In an embodiment, the hand-held computing device 702 further includes a prediction circuit 765 configured to predict a touch-contact site for the user appendage approaching the touch-sensitive display surface in response to the sensed relative motion. For example, a touch-contact site includes a portion of the touch-sensitive display surface where the approaching user appendage contacts, touches, or touches down on the touch-sensitive display surface, or is predicted to do so. In an embodiment, the prediction circuit is configured to predict a touch-contact site in response to a velocity or distance parameter of the sensed motion. For example, the velocity may include a perpendicular or closing velocity. The prediction may involve estimation of a time-to-impact, for example using closing velocity and distance information. The prediction may involve forward integration of the sensed motion over the time-to-impact. The prediction may involve forward projection of sensed motion profile up to intersection with the display surface. The prediction may be based on smoothing or filtering of the sensed motion. The prediction may be based on model-based filtration, such as Kalman filters, maximum-likelihood filters, of the sensed motion. In an embodiment, the hand-held computing device further includes a compensation circuit 760 configured to select the compensating adjustment in response to the predicted touch-contact site. In an embodiment, the selected compensating adjustment includes increasing a size of the displayed widget or the delineated touch-selectable area if the sensed motion indicates a trajectory approaching the delineated touch-selectable area. In an embodiment, the selected compensating adjustment includes increasing a size of the displayed widget or the delineated touch-selectable area if the sensed motion indicates a trajectory likely to impact the delineated touch-selectable area. In an embodiment, the selected compensating adjustment includes increasing a size of the displayed widget or the delineated touch-selectable area if the sensed motion indicates a trajectory likely to miss, but nearly impact the delineated touch-selectable area.

In an embodiment, the hand-held computing device 702 further includes an input circuit 770 configured to receive a signal indicative of a user touch to the delineated touch-selectable area or to an adjusted delineated touch-selectable area. This embodiment also includes an application 775 capable of running on a processor of the hand-held computing device and configured to execute an instruction associated with the displayed widget in response to the signal indicative of a user touch. In an embodiment, the mobile computing device further includes the communication device 385.

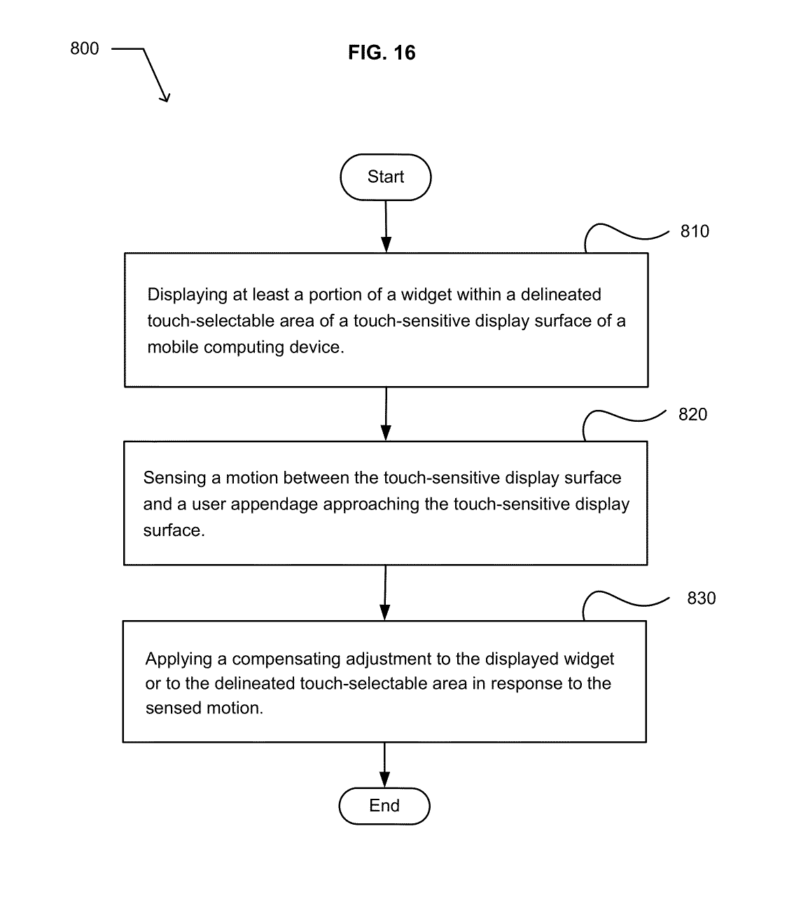

FIG. 16 illustrates an example operational flow 800. After a start operation, the operational flow includes an interface layout operation 810. The interface layout operation includes displaying at least a portion of a widget within a delineated touch-selectable area of a touch-sensitive display surface of a mobile computing device. In an embodiment, the interface layout operation may be implemented using the display circuit 730 described in conjunction with FIG. 15. A detection operation 820 includes sensing a motion between the touch-sensitive display surface and a user appendage approaching the touch-sensitive display surface. The detection operation may be implemented using the movement detector circuit 740 described in conjunction with FIG. 15. A motion compensation operation 830 includes applying a compensating adjustment to the displayed widget or to the delineated touch-selectable area in response to the sensed motion. The operational flow includes an end operation.

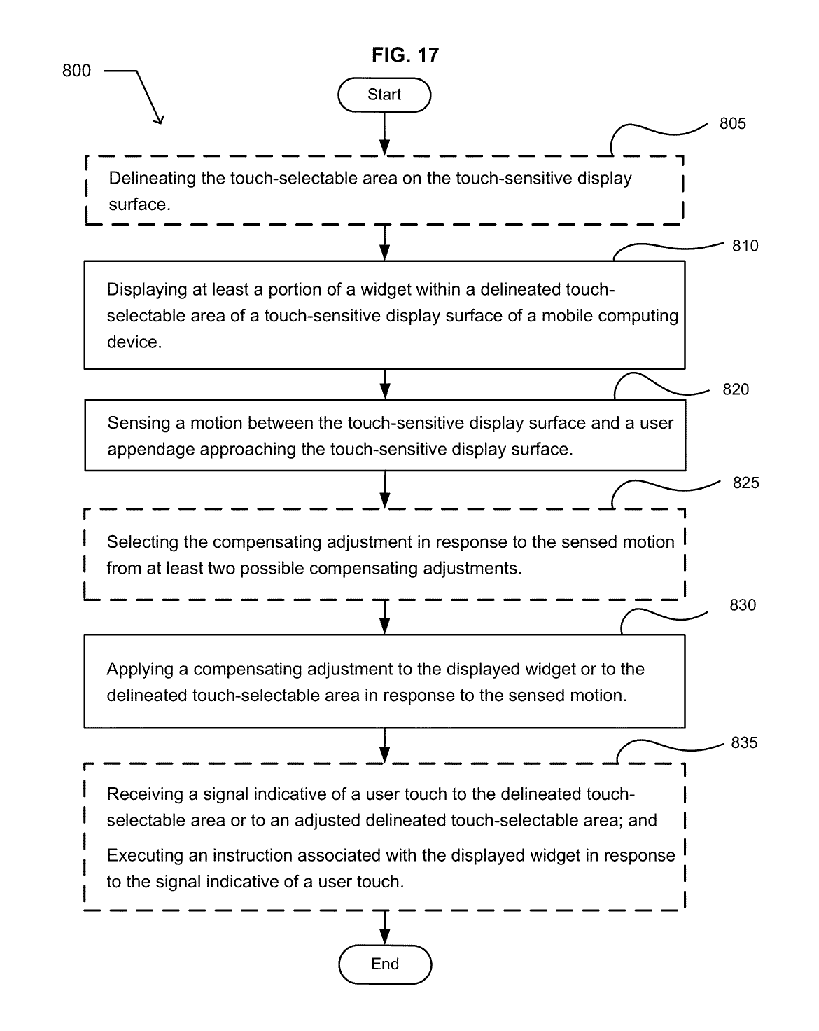

FIG. 17 illustrates an alternative embodiment to the operational flow 800 of FIG. 16. In an embodiment, the operational flow may include at least one additional operation. The at least one additional operation may include an operation 805, an operation 825, or an operation 835. The operation 805 includes delineating the touch-selectable area on the touch-sensitive display surface. The operation 825 includes selecting the compensating adjustment in response to the sensed motion from at least two possible compensating adjustments. The operation 835 includes receiving a signal indicative of a user touch to the delineated touch-selectable area or to an adjusted delineated touch-selectable area. The operation 835 also includes executing an instruction associated with the displayed widget in response to the signal indicative of a user touch.

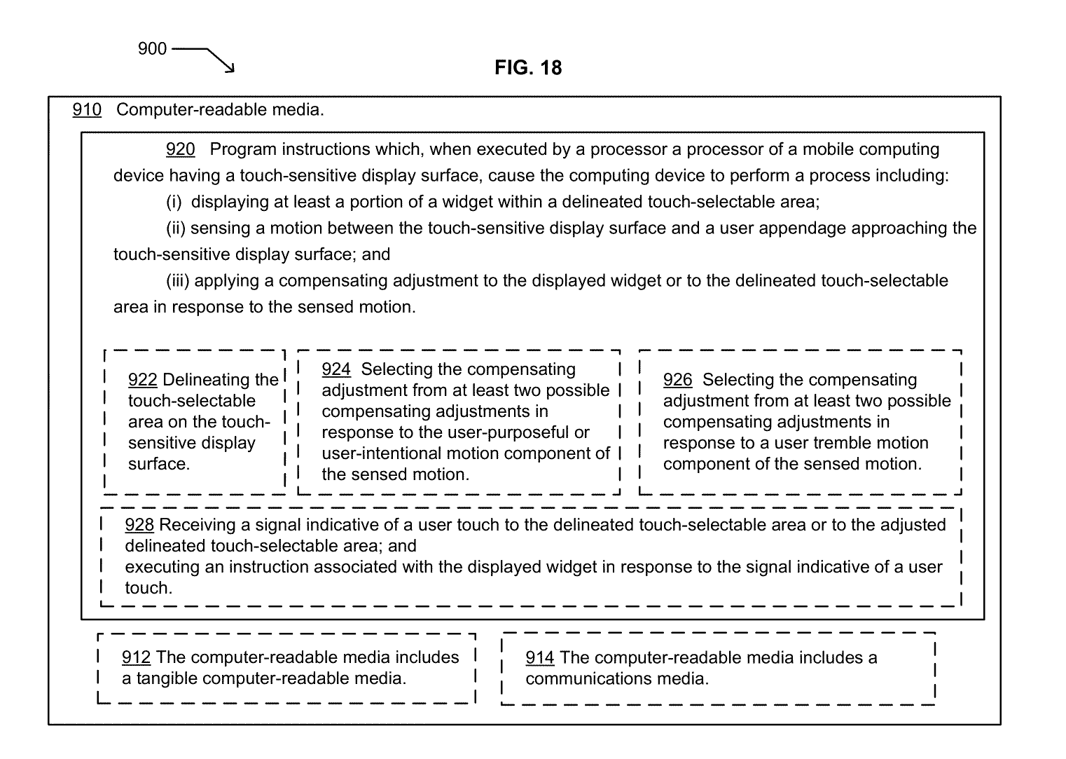

FIG. 18 illustrates an example computer program product 900. The computer program product includes a computer-readable media 910 bearing program instructions 920. The program instructions which, when executed by a processor of a mobile computing device having a touch-sensitive display surface, cause the computing device to perform a process. The process includes displaying at least a portion of a widget within the delineated touch-selectable area. The process includes sensing a motion between the touch-sensitive display surface and a user appendage approaching the touch-sensitive display surface. The process includes applying a compensating adjustment to the displayed widget or to the delineated touch-selectable area in response to the sensed motion.

In an embodiment, the program instructions 920 may include at least one additional process. The at least one additional process may include a process 922, a process 924, a process 926, or a process 928. The process 922 includes delineating the touch-selectable area on the touch-sensitive display surface. The process 924 includes selecting the compensating adjustment from at least two possible compensating adjustments in response to a user-purposeful or user-intentional motion component of the sensed motion. The process 926 includes selecting the compensating adjustment from at least two possible compensating adjustments in response to a user tremble motion component of the sensed motion. The process 928 includes receiving a signal indicative of a user touch to the delineated touch-selectable area or to an adjusted delineated touch-selectable area; and executing an instruction associated with the displayed widget in response to the signal indicative of a user touch.

In an embodiment, the computer-readable media 910 includes a tangible computer-readable media 912. In an embodiment, the computer-readable media includes a communication media 914.

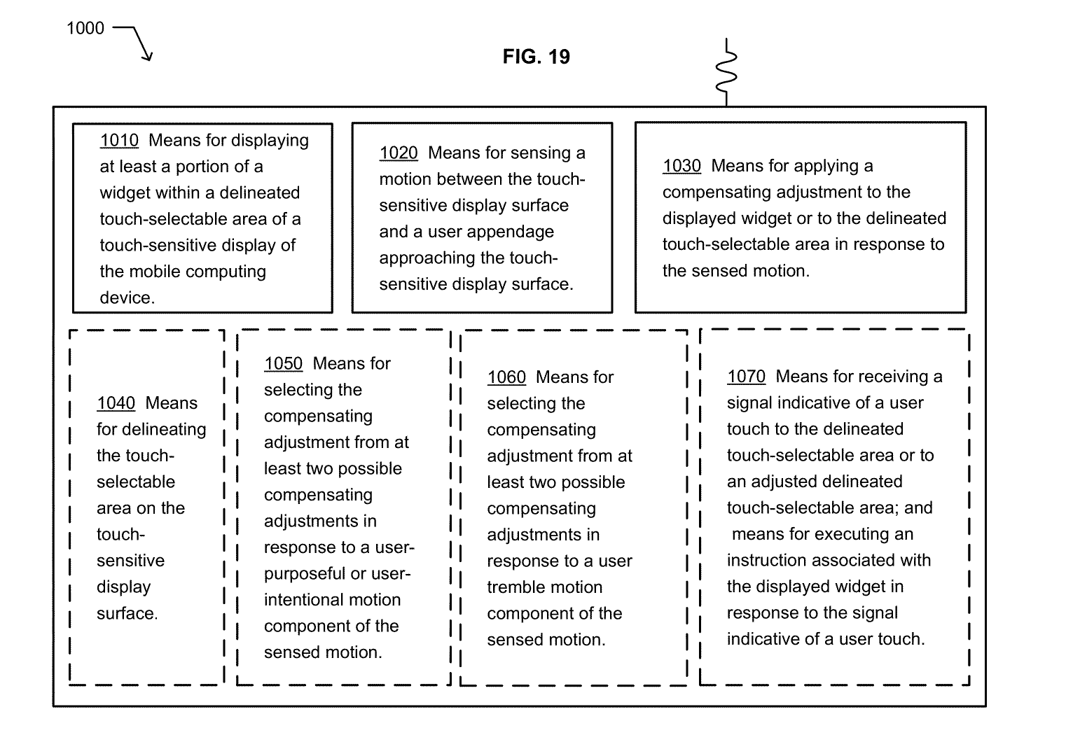

FIG. 19 illustrates an example hand-held computing device 1000 having a touch-sensitive display surface. The hand-held computing device includes means 1010 for displaying at least a portion of a widget within the delineated touch-selectable area. The hand-held computing device includes means 1020 for sensing a motion between the touch-sensitive display surface and a user appendage approaching the touch-sensitive display surface. The hand-held computing device includes means 1030 means for applying a compensating adjustment to the displayed widget or to the delineated touch-selectable area in response to the sensed motion.

In an embodiment, the hand-held computing device 1000 includes means 1040 for delineating the touch-selectable area on the touch-sensitive display surface. In an embodiment, the hand-held computing device includes means 1050 for selecting the compensating adjustment from at least two possible compensating adjustments in response to a user-purposeful or user-intentional motion component of the sensed motion. In an embodiment, the hand-held computing device includes means 1060 for receiving a signal indicative of a user touch to the delineated touch-selectable area or to an adjusted delineated touch-selectable area; and means for executing an instruction associated with the displayed widget in response to the signal indicative of a user touch.

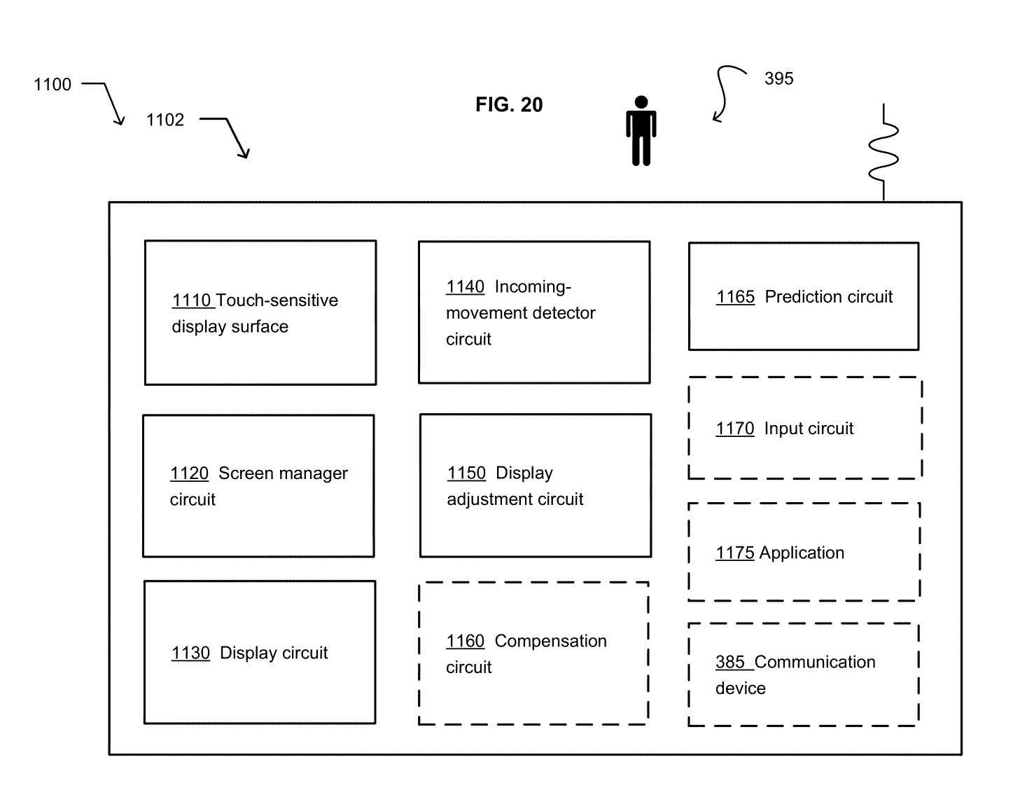

FIG. 20 illustrates an example environment 1100. The environment includes the user 395 and a hand-held computing device 1102. The hand-held computing device includes a touch-sensitive display surface 1110. The hand-held computing device includes a screen manager circuit 1120 configured to delineate a touch-selectable area on the touch-sensitive display surface. The hand-held computing device includes a display circuit 1130 configured to display a widget in a positional relationship with the delineated touch-selectable area. The hand-held computing device includes an incoming-movement detector circuit 1140 configured to sense a motion of a user appendage approaching the touch-sensitive display surface. The hand-held computing device includes a prediction circuit 1165 configured to predict a touch-contact site on the touch-sensitive display surface of the approaching user appendage, the predicted touch-contact site at least partially based on the sensed motion. The hand-held computing device includes a display adjustment circuit 1150 configured to apply a compensating adjustment to the displayed widget or the delineated touch-selectable area. The compensating adjustment is responsive to the predicted touch-contact site. In an embodiment, the hand-held computing device may be implemented in part or whole using the general purpose thin computing device 20 described in conjunction with FIG. 1. In an embodiment, the hand-held computing device may be implemented in part or whole using the general purpose computing device 100 described in conjunction with FIG. 2.

In an embodiment, the prediction circuit 1165 is configured to predict the touch-contact site at least partially in response to a velocity or distance component of the sensed motion. In an embodiment, the prediction circuit is configured to predict the touch-contact site at least partially in response to a user-purposeful or user-intentional motion component of the sensed motion. In an embodiment, the prediction circuit is configured to predict the touch-contact site at least partially in response to a tremble motion component of the sensed motion.

In an embodiment, the display adjustment circuit 1150 is configured to display at least a portion of the widget within the delineated touch-selectable area. In an embodiment, the incoming-movement detector circuit is configured to (i) sense an approaching-movement between the touch-sensitive display surface and a user appendage; and (ii) determine a tremble motion component of the approaching-movement. For example, the tremble motion component may be determined by filtering out the user-purposeful or user-intentional motion component. For example, the tremble motion component may be determined in response to or based on frequency of motion, on smoothed motion, size of motion, or rejection of most recent motions. In an embodiment, the incoming-movement detector circuit is configured to (i) sense an approaching-movement between the touch-sensitive display surface and a user appendage; and (ii) determine a user-purposeful or user-intentional motion component of the approaching-movement. For example, the user- purposeful or user-intentional motion component may be determined by filtering out a tremble motion component. For example, the tremble motion component may be determined in response to or based on frequency of motion, on smoothed motion, size of motion, or rejection of most recent motions. In an embodiment, the display adjustment circuit is configured to apply a compensating adjustment both to the displayed widget and to the delineated touch-selectable area in response to the predicted touch-contact site.

In an embodiment, the hand-held computing device includes a compensation circuit 1160 configured to select the compensating adjustment from at least two possible compensating adjustments in response to the predicted touch-contact site. In an embodiment, the compensation circuit is configured to select the compensating adjustment in response to a predicted trajectory component of the sensed motion and the predicted touch-contact site. In an embodiment, the compensation circuit is further configured to select the compensating adjustment in response to a sensed user-imparted tremble motion to the touch-sensitive display surface and the predicted touch-contact site.

In an embodiment, the compensating adjustment includes adjusting the positional relationship of the displayed widget with the delineated touch-selectable area. In an embodiment, the compensating adjustment includes increasing a displayed size of the widget and decreasing a displayed size of another widget proximate to the widget. In an embodiment, the compensating adjustment includes modifying the positional relationship between the widget and the delineated touch-selectable area. In an embodiment, the modifying the positional relationship includes repositioning the displayed widget with respect to the delineated touch-selectable area. In an embodiment, the modifying the positional relationship includes repositioning the delineated touch-selectable area with respect to the displayed widget. In an embodiment, the compensating adjustment includes reshaping one or both of the delineated touch-selectable area and the displayed widget. In an embodiment, the compensating adjustment includes displaying a ghosted, grayed out, or shaded version of the widget. In an embodiment, the compensating adjustment includes displaying a resized item menu. In an embodiment, the compensating adjustment includes displaying an animated version of the widget. In an embodiment, the compensating adjustment includes resizing the delineated touch-selectable area. In an embodiment, the compensating adjustment includes resizing the displayed widget. In an embodiment, the compensating adjustment includes dynamically moving the delineated touch-selectable area while leaving the widget unchanged. In an embodiment, the compensating adjustment includes co-displaying the widget at its positional relationship to the delineated touch-selectable area and another version of the widget at a motion compensated positional relationship to the delineated touch-selectable area. In an embodiment, the co-displaying includes simultaneously displaying the widget and the another version of the widget. In an embodiment, the co-displaying includes alternately displaying the widget and the another version of the widget. In an embodiment, the compensating adjustment includes displaying the widget using primarily one color and displaying the another version of the widget using primarily another color. In an embodiment, the compensating adjustment includes displaying the widget using a first transparency and displaying the another version of the widget using a second transparency.

In an embodiment, the hand-held computing device 1102 includes an input circuit 1170 configured to receive a signal indicative of a user touch to the delineated touch-selectable area or to an adjusted delineated touch-selectable area; and an application 1175 capable of running on a processor of the hand-held computing device and configured to execute an instruction associated with the displayed widget in response to the signal indicative of a user touch. In an embodiment, the hand-held computing device includes the communication device 385.

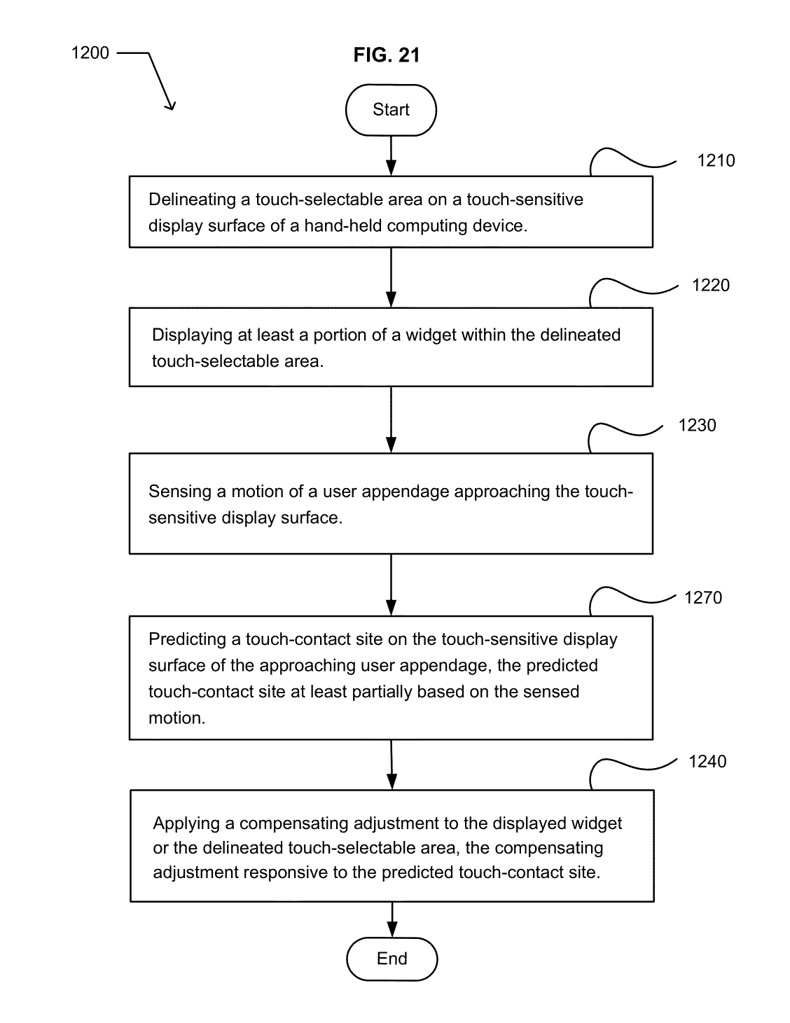

FIG. 21 illustrates an example operational flow 1200. After a start operation, the operational flow includes a plotting operation 1210. The plotting operation includes delineating a touch-selectable area on a touch-sensitive display surface of a hand-held computing device. In an embodiment, the plotting operation may be implemented using the screen manager circuit 1120 described in conjunction with FIG. 20. An interface layout operation 1220 includes displaying at least a portion of a widget within the delineated touch-selectable area. In an embodiment, the interface layout operation may be implemented using the display circuit 1130 described in conjunction with FIG. 20. A detection operation 1230 includes sensing a motion of a user appendage approaching the touch-sensitive display surface. In an embodiment, the detection operation may be implemented using the incoming movement detector circuit 1140 described in conjunction with FIG. 20. A forecasting operation 1270 includes predicting a touch-contact site on the touch-sensitive display surface of the approaching user appendage. The predicted touch-contact site is at least partially based on the sensed motion. In an embodiment, the forecasting operation may be implemented using the prediction circuit 1165 described in conjunction with FIG. 20. A motion compensation operation 1240 includes applying a compensating adjustment to the displayed widget or the delineated touch-selectable area. The compensating adjustment is responsive to the predicted touch-contact site. In an embodiment, the motion compensation operation may be implemented using the compensation circuit 1160 described in conjunction with FIG. 20. The operational flow includes an end operation.

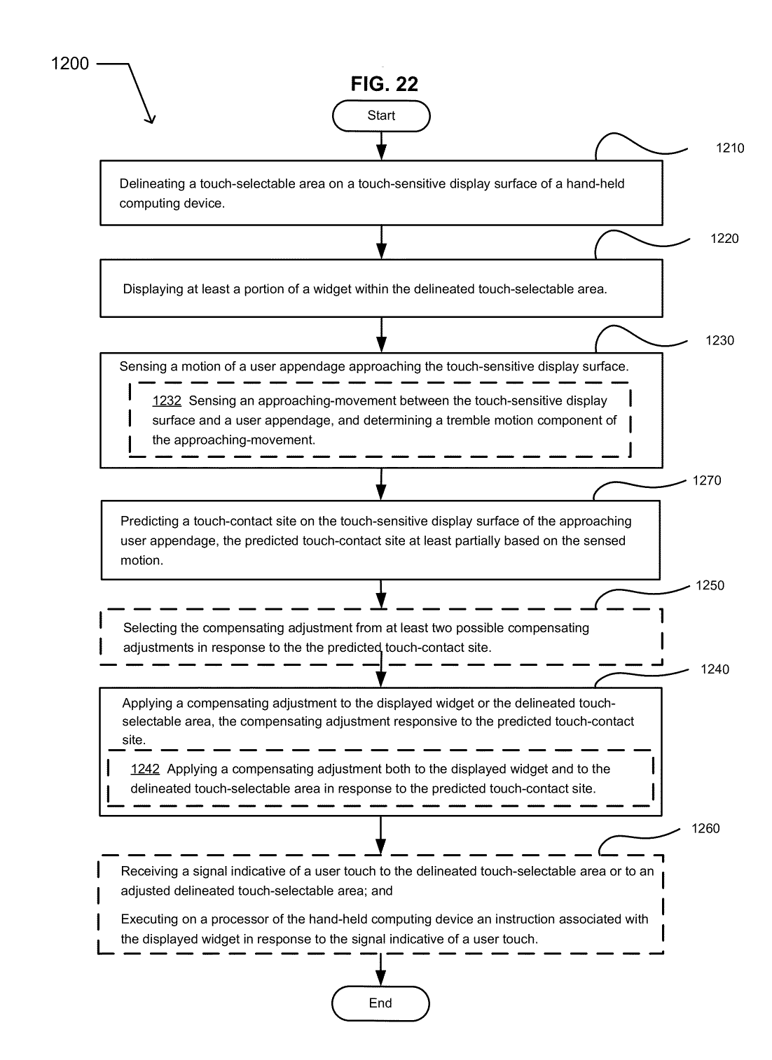

FIG. 22 illustrates an alternative embodiment of the operational flow 1200 of FIG. 21. In an embodiment, the detection operation 1230 includes an operation 1232 sensing an approaching-movement between the touch-sensitive display surface and a user appendage, and determining a tremble motion component of the approaching-movement. In an embodiment, the motion compensation operation 1240 includes an operation 1242 applying a compensating adjustment both to the displayed widget and to the delineated touch-selectable area in response to the predicted touch-contact site. In an embodiment, the operational flow includes an operation 1250 selecting the compensating adjustment from at least two possible compensating adjustments in response to the predicted touch-contact site. In an embodiment, the operational flow includes an operation 1260 that includes receiving a signal indicative of a user touch to the delineated touch-selectable area or to an adjusted delineated touch-selectable area. The operation 1260 also includes executing on a processor of the hand-held computing device an instruction associated with the displayed widget in response to the signal indicative of a user touch.

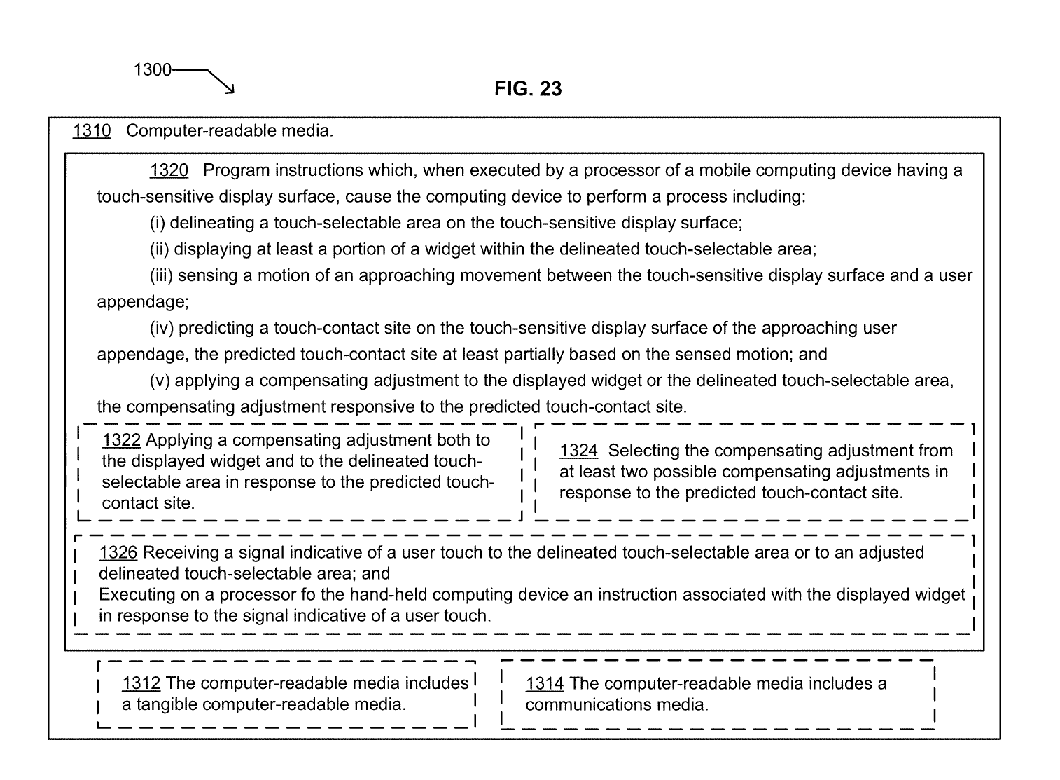

FIG. 23 illustrates a computer program product 1300. The computer program product includes a computer-readable media 1310 bearing the program instructions 1320. The program instructions which, when executed by a processor of a mobile computing device having a touch-sensitive display surface, cause the computing device to perform a process. The process includes delineating a touch-selectable area on the touch-sensitive display surface. The process includes displaying at least a portion of a widget within the delineated touch-selectable area. The process includes sensing a motion of an approaching movement between the touch-sensitive display surface and a user appendage. The process includes predicting a touch-contact site on the touch-sensitive display surface of the approaching user appendage. The predicted touch-contact site is at least partially based on the sensed motion. The process includes applying a compensating adjustment to the displayed widget or the delineated touch-selectable area, the compensating adjustment responsive to the predicted touch-contact site.

In an embodiment, the program instructions 1320 may include at least one additional process. The at least one additional process may include a process 1322, a process 1324, or a process 1326. The process 1322 includes applying a compensating adjustment both to the displayed widget and to the delineated touch-selectable area in response to the predicted touch-contact site. The process 1324 includes selecting the compensating adjustment from at least two possible compensating adjustments in response to the predicted touch-contact site. The process 1326 includes receiving a signal indicative of a user touch to the delineated touch-selectable area or to an adjusted delineated touch-selectable area. The process 1326 also includes executing on a processor of the hand-held computing device an instruction associated with the displayed widget in response to the signal indicative of a user touch.

In an embodiment, the computer-readable media 1310 includes a tangible computer-readable media 1312. In an embodiment, the computer-readable media includes a communication media 1314.

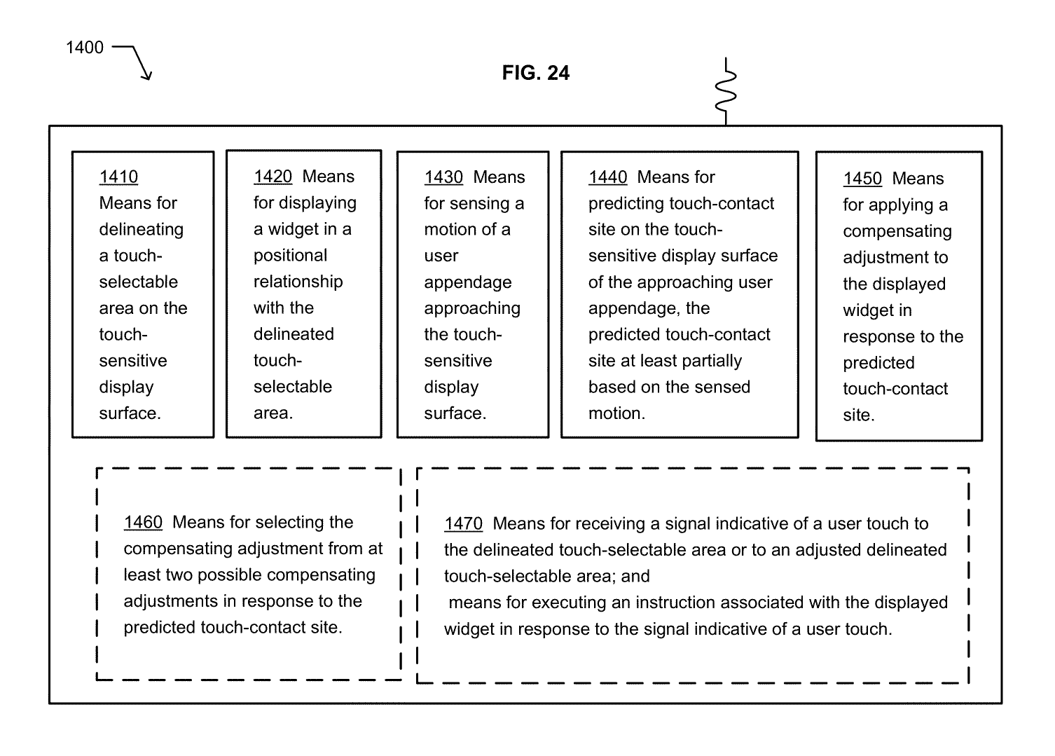

FIG. 24 illustrates an example hand-held computing device 1400 having a touch-sensitive display surface. The device includes means 1410 for delineating a touch-selectable area on the touch-sensitive display surface. The device includes means 1420 for displaying a widget in a positional relationship with the delineated touch-selectable area. The device includes means 1430 for sensing a motion of a user appendage approaching the touch-sensitive display surface. The device includes means 1440 for predicting touch-contact site on the touch-sensitive display surface of the approaching user appendage. The predicted touch-contact site is at least partially based on the sensed motion. The device includes means 1450 for applying a compensating adjustment to the displayed widget in response to the predicted touch-contact site.

In an embodiment, the device 1400 includes means 1460 for selecting the compensating adjustment from at least two possible compensating adjustments in response to the predicted touch-contact site. In an embodiment, the device includes means 1470 for receiving a signal indicative of a user touch to the delineated touch-selectable area or to an adjusted delineated touch-selectable area. The means 1470 also includes means for executing on a processor of the hand-held computing device an instruction associated with the displayed widget in response to the signal indicative of a user touch.

All references cited herein are hereby incorporated by reference in their entirety or to the extent their subject matter is not otherwise inconsistent herewith.

In some embodiments, “configured” includes at least one of designed, set up, shaped, implemented, constructed, or adapted for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A hand-held computing device having a touch-sensitive display surface, the device comprising:
a screen manager circuit configured to delineate a touch-selectable area on the touch-sensitive display surface;
a display circuit configured to display a widget in a positional relationship with the delineated touch-selectable area;
an incoming-movement detector circuit configured to sense a motion of a user appendage approaching the touch-sensitive display surface;
a prediction circuit configured to predict a touch-contact site on the touch-sensitive display surface of the approaching user appendage, the predicted touch-contact site at least partially based on the sensed motion; and
a display adjustment circuit configured to apply a compensating adjustment to the displayed widget or the delineated touch-selectable area, the compensating adjustment responsive to the predicted touch-contact site.

2. The hand-held computing device of claim 1, wherein the prediction circuit is configured to predict the touch-contact site at least partially in response to a velocity or distance component of the sensed motion.

3. The hand-held computing device of claim 1, wherein the prediction circuit is configured to predict the touch-contact site at least partially in response to a user-purposeful or user-intentional motion component of the sensed motion.

4. The hand-held computing device of claim 1, wherein the prediction circuit is configured to predict the touch-contact site at least partially in response to a tremble motion component of the sensed motion.

5. The hand-held computing device of claim 1, wherein the display adjustment circuit is configured to display at least a portion of the widget within the delineated touch-selectable area.

6. The hand-held computing device of claim 1, wherein the incoming-movement detector circuit is configured to (i) sense an approaching-movement between the touch-sensitive display surface and a user appendage; and (ii) determine a tremble motion component of the approaching-movement.

7. The hand-held computing device of claim 1, wherein the incoming-movement detector circuit is configured to (i) sense an approaching-movement between the touch-sensitive display surface and a user appendage; and (ii) determine a user-purposeful or user-intentional motion component of the approaching movement.

8. The hand-held computing device of claim 1, wherein the display adjustment circuit is configured to apply a compensating adjustment both to the displayed widget and to the delineated touch-selectable area in response to the predicted touch-contact site.

9. The hand-held computing device of claim 1, further comprising:
a compensation circuit configured to select the compensating adjustment from at least two possible compensating adjustments in response to the predicted touch-contact site.

10. The hand-held computing device of claim 9, wherein the compensation circuit is configured to select the compensating adjustment in response to a predicted trajectory component of the sensed motion and the predicted touch-contact site.

11. The hand-held computing device of claim 9, wherein the compensation circuit is further configured to select the compensating adjustment in response to a sensed user-imparted tremble motion to the touch-sensitive display surface and the predicted touch-contact site.

12. The hand-held computing device of claim 1, wherein the compensating adjustment includes adjusting the positional relationship of the displayed widget with the delineated touch-selectable area.

13. The hand-held computing device of claim 1, wherein the compensating adjustment includes increasing a displayed size of the widget and decreasing a displayed size of another widget proximate to the widget.

14. The hand-held computing device of claim 1, wherein the compensating adjustment includes modifying the positional relationship between the widget and the delineated touch-selectable area.

15. The hand-held computing device of claim 14, wherein the modifying the positional relationship includes repositioning the displayed widget with respect to the delineated touch-selectable area.

16. The hand-held computing device of claim 14, wherein the modifying the positional relationship includes repositioning the delineated touch-selectable area with respect to the displayed widget.

17. The hand-held computing device of claim 1, wherein the compensating adjustment includes displaying a ghosted, grayed out, or shaded version of the widget.

18. The hand-held computing device of claim 1, wherein the compensating adjustment includes displaying a resized item menu.

19. The hand-held computing device of claim 1, wherein the compensating adjustment includes displaying an animated version of the widget.

20. The hand-held computing device of claim 1, wherein the compensating adjustment includes resizing the delineated touch-selectable area.

21. The hand-held computing device of claim 1, wherein the compensating adjustment includes resizing the widget.

22. The hand-held computing device of claim 1, wherein the compensating adjustment includes moving both the delineated touch-selectable area and the widget relative to the touch-sensitive display surface, but not with respect to each other.

23. The hand-held computing device of claim 1, wherein the compensating adjustment includes reshaping the delineated touch-selectable area or the widget.

24. The hand-held computing device of claim 1, wherein the compensating adjustment includes dynamically moving the delineated touch-selectable area while leaving the widget unchanged.

25. The hand-held computing device of claim 1, wherein the compensating adjustment includes co-displaying the widget at its positional relationship to the delineated touch-selectable area and another version of the widget at a motion compensated positional relationship to the delineated touch-selectable area.

26. (canceled)

27. (canceled)

28. The hand-held computing device of claim 1, wherein the compensating adjustment includes displaying the widget using primarily one color and displaying another version of the widget using primarily another color.

29. The hand-held computing device of claim 1, wherein the compensating adjustment includes displaying the widget using a first transparency and displaying another version of the widget using a second transparency.

30. The hand-held computing device of claim 1, further comprising:
an input circuit configured to receive a signal indicative of a user touch to the delineated touch-selectable area or to an adjusted delineated touch-selectable area; and
an application capable of running on a processor of the hand-held computing device and configured to execute an instruction associated with the displayed widget in response to the signal indicative of a user touch.

31. A method comprising:
delineating a touch-selectable area on a touch-sensitive display surface of a hand-held computing device;
displaying at least a portion of a widget within the delineated touch-selectable area;
sensing a motion of a user appendage approaching the touch-sensitive display surface;
predicting a touch-contact site on the touch-sensitive display surface of the approaching user appendage, the predicted touch-contact site at least partially based on the sensed motion; and
applying a compensating adjustment to the displayed widget or the delineated touch-selectable area, the compensating adjustment responsive to the predicted touch-contact site.

32. The method of claim 31, wherein the sensing includes sensing an approaching-movement between the touch-sensitive display surface and a user appendage, and determining a tremble motion component of the approaching-movement.

33. The method of claim 31, wherein the applying includes applying a compensating adjustment both to the displayed widget and to the delineated touch-selectable area in response to the predicted touch-contact site.

34. The method of claim 31, further comprising:
selecting the compensating adjustment from at least two possible compensating adjustments in response to the predicted touch-contact site.

35. The method of claim 31, further comprising:
receiving a signal indicative of a user touch to the delineated touch-selectable area or to an adjusted delineated touch-selectable area; and
executing on a processor of the hand-held computing device an instruction associated with the displayed widget in response to the signal indicative of a user touch.

36. A computer program product comprising:
(a) program instructions which, when executed by a processor of a mobile computing device having a touch-sensitive display surface, cause the computing device to perform a process including:
(i) delineating a touch-selectable area on the touch-sensitive display surface;
(ii) displaying at least a portion of a widget within the delineated touch-selectable area;
(iii) sensing a motion of an approaching movement between the touch-sensitive display surface and a user appendage;
(iv) predicting a touch-contact site on the touch-sensitive display surface of the approaching user appendage, the predicted touch-contact site at least partially based on the sensed motion; and
(v) applying a compensating adjustment to the displayed widget or the delineated touch-selectable area, the compensating adjustment responsive to the predicted touch-contact site; and
(b) computer-readable media bearing the program instructions.

37. The computer program product of claim 36, wherein the applying includes:
applying a compensating adjustment both to the displayed widget and to the delineated touch-selectable area in response to the predicted touch-contact site.

38. The computer program product of claim 36, the process further comprising:
selecting the compensating adjustment from at least two possible compensating adjustments in response to the predicted touch-contact site.

39. The computer program product of claim 36, the process further comprising:
receiving a signal indicative of a user touch to the delineated touch-selectable area or to an adjusted delineated touch-selectable area; and
executing on a processor of the hand-held computing device an instruction associated with the displayed widget in response to the signal indicative of a user touch.

40. The computer program product of claim 36, wherein the computer-readable media includes a tangible computer-readable media.

41. The computer program product of claim 36, wherein the computer-readable media includes a communication media.

42. A hand-held computing device having a touch-sensitive display surface, the device comprising:
means for delineating a touch-selectable area on the touch-sensitive display surface;
means for displaying a widget in a positional relationship with the delineated touch-selectable area;
means for sensing a motion of a user appendage approaching the touch-sensitive display surface;
means for predicting touch-contact site on the touch-sensitive display surface of the approaching user appendage, the predicted touch-contact site at least partially based on the sensed motion; and
means for applying a compensating adjustment to the displayed widget in response to the predicted touch-contact site.

43. The device of claim 42, further comprising:
means for selecting the compensating adjustment from at least two possible compensating adjustments in response to the predicted touch-contact site.

44. The device of claim 42, further comprising:
means for receiving a signal indicative of a user touch to the delineated touch-selectable area or to an adjusted delineated touch-selectable area; and
means for executing on a processor of the hand-held computing device an instruction associated with the displayed widget in response to the signal indicative of a user touch.
